(19) United States
(12) Patent Application Publication
(10) Pub. No.: US 2020/0329202 A1
(43) Pub. Date: Oct. 15, 2020

(54) IMAGE CAPTURING APPARATUS, CONTROL METHOD, AND RECORDING MEDIUM

(71) Applicant: CANON KABUSHIKI KAISHA, Tokyo (JP)

(72) Inventors: Yusuke Toriumi, Tokyo (JP); Kikuo Kazama, Kawasaki-shi (JP); Ryosuke Sato, Yokohama-shi (JP); Yuki Tsujimoto, Tokyo (JP)

(21) Appl. No.: 16/910,622

(22) Filed: Jun. 24, 2020

Related U.S. Application Data
(63) Continuation of application No. PCT/JP2018/042695, filed on Nov. 19, 2018.

(30) Foreign Application Priority Data
Dec. 26, 2017 (JP) 2017-250108
Nov. 2, 2018 (JP) 2018-207634

(51) Int. Cl. H04N 5/232; H04R 1/40; H04R 3/00; H04R 1/08

(52) U.S. Cl. CPC H04N 5/23299; H04R 1/08; H04R 3/005; H04R 1/406

(57) ABSTRACT

An image capturing apparatus comprising: an image capturing unit; a driving unit for moving an image capturing direction; a first detection unit; a second detection unit; a sound input unit including a plurality of microphones; a third detection unit; and a control unit, wherein the control unit determines microphones of the sound input unit, based on the direction of the user detected by the first detection unit and the movement of the image capturing apparatus detected by the second detection unit, wherein the third detection unit detects a direction of a sound source of the voice collected by microphones, and wherein, in a case where the third detection unit has detected the direction of the sound source of the voice, the control unit controls the driving unit to move the image capturing direction of the image capturing unit to direct toward the direction of the sound source.

### CROSS-REFERENCE TO RELATED APPLICATIONS

This application is a Continuation of International Patent Application No. PCT/JP2018/042695, filed Nov. 19, 2018, which claims the benefit of Japanese Patent Application No. 2017-250108, filed Dec. 26, 2017 and Japanese Patent Application No. 2018-207634, filed Nov. 2, 2018 both of which are hereby incorporated by reference herein in their entirety.

### BACKGROUND

### Field of the Disclosure

The present disclosure relates to an image capturing apparatus, a control method thereof, and a recording medium.

### Description of the Related Art

When a still image or a moving image is shot using an image capturing apparatus such as a camera, a user usually shoots an image after determining a shooting target through a finder or the like, and confirming the shooting situation by him/herself and adjusting the framing of an image to be. Such an image capturing apparatus is provided with a function of notifying, upon detection of an error, the user of an operational error made by the user, or detecting the external environment and notifying the user of being in an environment not suitable for shooting. Also, there is a known mechanism in which a camera is controlled to enter a state suitable for shooting.

In contrast to such an image capturing apparatus that executes shooting in accordance with a user operation, a life log camera in the publication of Japanese Patent Laid-Open No. 2016-536868 is present that performs shooting intermittently and successively without a user giving shooting instructions.

However, because a known life log camera of a type that is attached to the body of a user performs automatic shooting regularly, there are cases where the images obtained by capturing are not those intended by the user.

The present disclosure has been made in view of the foregoing problem, and aims to provide a technique that enables shooting of an image at a timing intended by a user with a composition intended by the user, without the user performing a special operation.

### SUMMARY

An image capturing apparatus comprising: an image capturing unit; a driving unit for moving an image capturing direction of the image capturing unit; a first detection unit for detecting a direction of a user to whom the image capturing apparatus is attached; a second detection unit for detecting a movement of the image capturing apparatus; a sound input unit including a plurality of microphones; a third detection unit for detecting a direction of a sound source of a voice collected by the sound input unit; and a control unit, wherein the control unit determines two or more microphones of the sound input unit, based on the direction of the user detected by the first detection unit and on the movement of the image capturing apparatus detected by the second detection unit, wherein the third detection unit detects a direction of a sound source of the voice collected by two or more microphones of the sound input unit determined by the control unit, and wherein, in a case where the third detection unit has detected the direction of the sound source of the voice by the determined two or more microphones of the sound input unit, the control unit controls the driving unit to move the image capturing direction of the image capturing unit to direct toward the direction of the sound source detected by the third detection unit.

Further features of various embodiments will become apparent from the following description of exemplary embodiments with reference to the attached drawings.

### BRIEF DESCRIPTION OF THE DRAWINGS

The attached drawings are included in the specification and constitute a part of the specification, illustrate embodiments of the present disclosure, and are used to describe the principle of the present disclosure together with the description of the specification.

FIG. 1 is a block diagram of an image capturing apparatus according to an embodiment.

FIG. 2 is a detailed block diagram of a sound input unit and a sound signal processing unit according to an embodiment.

FIG. 3A is a top view and a front view of the image capturing apparatus according to an embodiment.

FIG. 3B is a diagram illustrating an example of use of the image capturing apparatus in an embodiment.

FIG. 3C is a diagram illustrating an example of use of the image capturing apparatus in an embodiment.

FIG. 3D is a diagram illustrating an example of use of the image capturing apparatus in an embodiment.

FIG. 3E is a diagram illustrating an example of use of the image capturing apparatus in an embodiment.

FIG. 4 is a diagram illustrating panning and tilting operations of the image capturing apparatus according to an embodiment.

FIG. 5A is a flowchart illustrating a processing procedure of a central control unit in an embodiment.

FIG. 5B is a flowchart illustrating the processing procedure of the central control unit in an embodiment.

FIG. 6 is a flowchart illustrating the details of voice command processing in FIG. 5B.

FIG. 7 is a diagram illustrating the relationship between meanings of voice commands and the voice commands in an embodiment.

FIG. 8 is a timing chart from activation to an operation shooting start command in an embodiment.

FIG. 9A is a diagram illustrating a sound direction detection method according to an embodiment.

FIG. 9B is a diagram illustrating the sound direction detection method according to an embodiment.

FIG. 9C is a diagram illustrating the sound direction detection method according to an embodiment.

FIG. 10A is a diagram illustrating a detection method when a sound source is present right above the image capturing apparatus.

FIG. 10B is a diagram illustrating the detection method when a sound source is present right above the image capturing apparatus.

FIG. 11 is a flowchart illustrating processing for detecting an installation position in a first embodiment.

FIG. 12A is a diagram illustrating a principle of detecting the sound source direction for each installation position in the first embodiment.

FIG. 12B is a diagram illustrating a principle of detecting the sound source direction for each installation position in the first embodiment.

FIG. 12C is a diagram illustrating a principle of detecting the sound source direction for each installation position in the first embodiment.

FIG. 13A is a diagram illustrating a detection range of a sound source for each installation position in the first embodiment.

FIG. 13B is a diagram illustrating a detection range of a sound source for each installation position in the first embodiment.

FIG. 13C is a diagram illustrating a detection range of a sound source for each installation position in the first embodiment.

FIG. 14A is a diagram illustrating a use mode of an image capturing apparatus 1 in a second embodiment.

FIG. 14B is a diagram illustrating a masked region in the use mode in FIG. 14A.

FIG. 14C is a diagram illustrating a use mode of the image capturing apparatus 1 in the second embodiment.

FIG. 14D is a diagram illustrating a masked region in the use mode in FIG. 14C.

FIG. 14E is a diagram illustrating a use mode of the image capturing apparatus 1 in the second embodiment.

FIG. 14F is a diagram illustrating a masked region in the use mode in FIG. 14E.

FIG. 15A is a flowchart illustrating a processing procedure of a central control unit in the second embodiment.

FIG. 15B is a flowchart illustrating a processing procedure of the central control unit in the second embodiment.

FIG. 16 is a diagram illustrating a problem in a third embodiment.

FIG. 17 is a flowchart illustrating a processing procedure of a central control unit in the third embodiment.

FIG. 18 is a diagram illustrating improved operations in the third embodiment.

FIG. 19 is a flowchart illustrating a processing procedure of a central control unit in a modification of the third embodiment.

FIG. 20 is a diagram illustrating improved operations in the modification of the third embodiment.

FIG. 21A is a diagram illustrating the relationship between sensitivity in sound direction and an angle of view in a fourth embodiment.

FIG. 21B is a diagram illustrating the relationship between sensitivity in sound direction and an angle of view in the fourth embodiment.

FIG. 22A is a diagram illustrating the relationship between sensitivity in sound direction and an angle of view when the zoom ratio is increased in the fourth embodiment.

FIG. 22B is a diagram illustrating the relationship between sensitivity in sound direction and an angle of view when the zoom ratio is increased in the fourth embodiment.

FIG. 22C is a diagram illustrating the relationship between sensitivity in sound direction and an angle of view when the zoom ratio is increased in the fourth embodiment.

FIG. 23 is a diagram illustrating the relationship between detection resolution in sound direction and a processing load.

FIG. 24A is a diagram illustrating the relationship between a shooting angle of view in a horizontal direction and detection resolution in the horizontal direction when the sound direction is detected in the fourth embodiment.

FIG. 24B is a diagram illustrating the relationship between a shooting angle of view in the horizontal direction and detection resolution in the horizontal direction when the sound direction is detected in the fourth embodiment.

FIG. 24C is a diagram illustrating the relationship between a shooting angle of view in the horizontal direction and detection resolution in the horizontal direction when the sound direction is detected in the fourth embodiment.

FIG. 25 is a flowchart illustrating a processing procedure of a central control unit when a voice command of zoom ratio is received in the fourth embodiment.

FIG. 26A is a diagram illustrating operation contents of an image capturing apparatus in the fourth embodiment.

FIG. 26B is a diagram illustrating operation contents of the image capturing apparatus in the fourth embodiment.

FIG. 26C is a diagram illustrating operation contents of the image capturing apparatus in the fourth embodiment.

FIG. 26D is a diagram illustrating operation contents of the image capturing apparatus in the fourth embodiment.

### DESCRIPTION OF THE EMBODIMENTS

Hereinafter, embodiments will be described in detail according to the attached drawings.

### First Embodiment

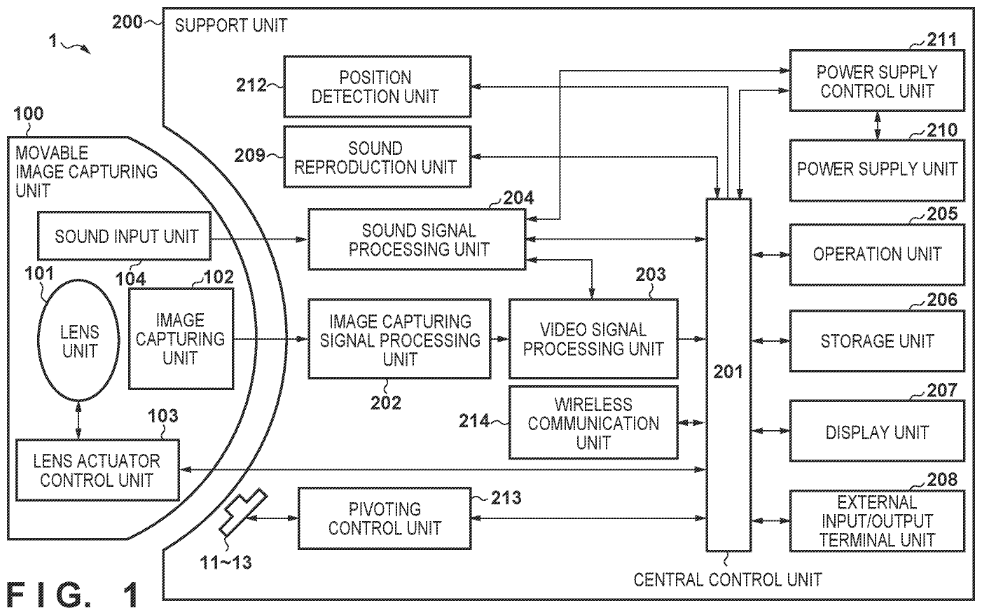

FIG. 1 is a block configuration diagram of an image capturing apparatus 1 according to a first embodiment. The image capturing apparatus 1 is constituted by a movable image capturing unit 100 that includes an optical lens unit, and in which the direction in which image capturing is performed (optical axis direction) is variable, and a support unit 200 that includes a central control unit (CPU) that performs drive control of the movable image capturing unit 100, and controls the entirety of the image capturing apparatus.

Note that the support unit 200 is provided with a plurality of driving units 11 to 13 including piezoelectric elements in contact with a face of the movable image capturing unit 100. The movable image capturing unit 100 performs panning and tilting operations by controlling the vibrations of these driving units 11 to 13. Note that the configuration may be such that the panning and tilting operations are realized using servomotors or the like.

The movable image capturing unit 100 includes a lens unit 101, an image capturing unit 102, a lens actuator control unit 103, and a sound input unit 104.

The lens unit 101 is constituted by a shooting optical system including a zoom lens, a diaphragm/shutter, a focus lens, and the like. The image capturing unit 102 includes an image sensor such as a CMOS sensor or a CCD sensor, photoelectrically converts an optical image formed by the lens unit 101 to an electric signal, and outputs the electric signal. The lens actuator control unit 103 includes a motor driver IC, and drives various actuators for the zoom lens, the diaphragm/shutter, the focus lens, and the like of the lens unit 101. The various actuators are driven based on actuator drive instruction data received from a central control unit 201 in the support unit 200, which will be described later. The sound input unit 104 is a sound input unit including a microphone (hereinafter, mic), and is constituted by a plurality of mics (four mics, in the present embodiment), and converts a sound signal to an electric signal, converts the electric signal to a digital signal (sound data), and outputs the digital signal.

Meanwhile, the support unit 200 includes the central control unit 201 for controlling the entirety of the image capturing apparatus 1. The central control unit 201 is constituted by a CPU, a ROM in which programs to be executed by the CPU are stored, and a RAM that is used as a work area of the CPU. Also, the support unit 200 includes an image capturing signal processing unit 202, a video signal processing unit 203, a sound signal processing unit 204, an operation unit 205, a storage unit 206, and a display unit 207. The support unit 200 further includes an external input/output terminal unit 208, a sound reproduction unit 209, a power supply unit 210, a power supply control unit 211, a position detection unit 212, a pivoting control unit 213, a wireless communication unit 214, and the driving units 11 to 13 described above.

The image capturing signal processing unit 202 converts an electric signal output from the image capturing unit 102 of the movable image capturing unit 100 to a video signal. The video signal processing unit 203 processes the video signal output from the image capturing signal processing unit 202 in accordance with the application. The processing of the video signal includes cutting-out of an image, an electronic image stabilization operation realized by rotation processing, and subject detection processing for detecting a subject (face).

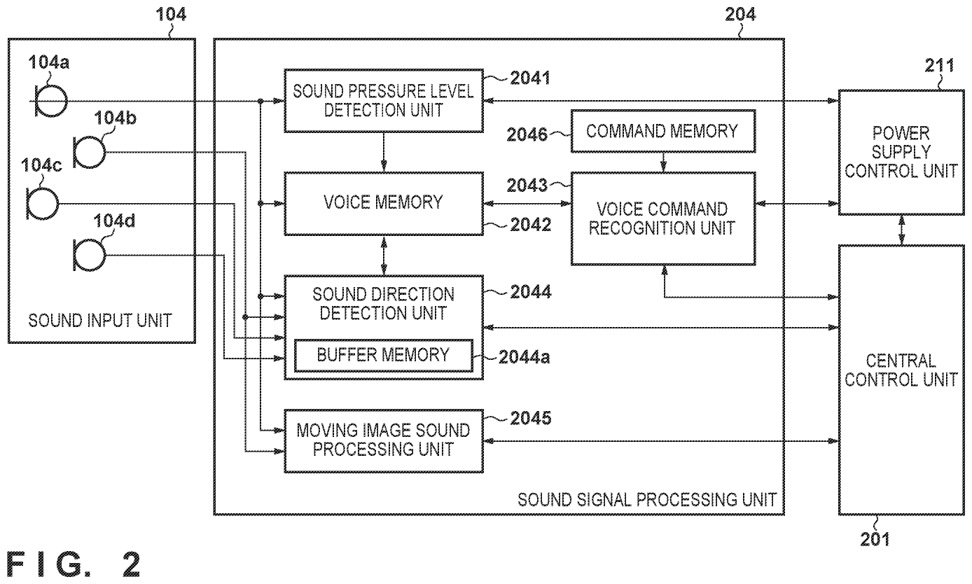

The sound signal processing unit 204 performs sound processing on a digital signal from the sound input unit 104. When the sound input unit 104 has an electric analog output, the sound signal processing unit 204 may include a constituent element that converts an electric analog signal to a digital signal. Note that the details of the sound signal processing unit 204 including the sound input unit 104 will be described later using FIG. 2.

The operation unit 205 functions as a user interface between the image capturing apparatus 1 and a user, and is constituted by various switches, buttons, and the like. The storage unit 206 stores various types of data such as video information obtained by shooting. The display unit 207 includes a display such as an LCD, and displays an image as necessary based on a signal output from the video signal processing unit 203. Also, the display unit 207 functions as a portion of the user interface by displaying various menus and the like. The external input/output terminal unit 208 receives/outputs a communication signal and a video signal from/to an external apparatus. The sound reproduction unit 209 includes a speaker, converts sound data to an electric signal, and reproduces sound. The power supply unit 210 is a power supply source necessary for driving the entirety (constituent elements) of the image capturing apparatus, and is assumed to be a rechargeable battery in the present embodiment.

The power supply control unit 211 controls supply/cutoff of power from the power supply unit 210 to each of the constituent elements described above in accordance with the state of the image capturing apparatus 1. A constituent element that is not used is present depending on the state of the image capturing apparatus 1. The power supply control unit 211 executes a function of suppressing power consumption by cutting off power to constituent elements that are not used in accordance with the state of the image capturing apparatus 1 under the control of the central control unit 201. Note that the power supply/cutoff will be made clear by a description given later.

The position detection unit 212 detects a movement of the image capturing apparatus 1 using a gyroscope, an acceleration sensor, GPS, and the like. The position detection unit 212 is also for dealing with a case where the user attaches the image capturing apparatus 1 to his/her body. The pivoting control unit 213 generates signals for driving the driving units 11 to 13 in accordance with an instruction of the optical axis direction from the central control unit 201, and outputs the signals. The piezoelectric elements of driving units 11 to 13 vibrate in accordance with driving signals applied from the pivoting control unit 213, and move the optical axis direction of movable image capturing unit 100. As a result, the movable image capturing unit 100 performs panning and tilting operations in a direction instructed by the central control unit 201.

A wireless unit 214 performs data transmission of image data or the like in conformity to a wireless standard such as Wifi or BLE (Bluetooth Low Energy).

Next, the configurations of the sound input unit 104 and the sound signal processing unit 204 in the present embodiment, and sound direction detection processing will be described with reference to FIG. 2. FIG. 2 illustrates configurations of the sound input unit 104 and the sound signal processing unit 204, and a connection relationship between the sound signal processing 204, the central control unit 201, and the power supply control unit 211.

The sound input unit 104 is constituted by four nondirectional mics (mics 104a, 104b, and 104c, and mic 104d). Each mic includes an A/D converter, samples sound at a preset sampling rate (command detection and direction detection processing: 16 kHz, moving image recording: 48 kHz), converts the sound signal obtained by sampling to digital sound data using the internal A/D converter, and outputs the digital sound data. Note that, in the present embodiment, the sound input unit 104 is constituted by four digital mics, but may also be constituted by mics having an analog output. In the case of an analog mic, a corresponding A/D converter need only be provided in the sound signal processing unit 204. Also, the number of microphones in the present embodiment is four, but the number need only be three or more.

The mic 104a is unconditionally supplied with power when the image capturing apparatus 1 is powered on, and enters a sound collectable state. On the other hand, the other mics 104b, 104c, and 104d are targets of power supply/cutoff by the power supply control unit 211 under the control of the central control unit 201, and the power thereto is cut off in an initial state after the image capturing apparatus 1 has been powered on.

The sound signal processing unit 204 is constituted by a sound pressure level detection unit 2041, a voice memory 2042, a voice command recognition unit 2043, a sound direction detection unit 2044, a moving image sound processing unit 2045, and a command memory 2046.

When the output level indicated by sound data from the mic 104a exceeds a preset threshold value, the sound pressure level detection unit 2041 supplies a signal indicating that sound has been detected to the power supply control unit 211 and the voice memory 2042.

The power supply control unit 211, upon receiving the signal indicating that sound has been detected from the sound pressure level detection unit 2041, supplies power to the voice command recognition unit 2043.

The voice memory 2042 is one of the targets of power supply/cutoff by the power supply control unit 211 under the control of the central control unit 201. Also, the voice memory 2042 is a buffer memory that temporarily stores sound data from the mic 104a. The voice memory 2042 has such a capacity that all sampling data obtained when the longest voice command is spoken relatively slowly can be stored. When the sampling rate of the mic 104a is 16 kHz, sound data of two bytes (16 bit) per sampling is output, and the longest voice command is assumed to be five seconds, the voice memory 2042 needs to have a capacity of about 160 Kbytes (≅5×16×1000×2). Also, when the capacity of the voice memory 2042 is filled with sound data from the mic 104a, old sound data is over-written by new sound data. As a result, the voice memory 2042 holds sound data of the most recent predetermined period (five seconds, in the above example). Also, the voice memory 2042 starts storing sound data from the mic 104a in a sampling data region triggered by the reception of the signal indicating that sound has been detected from the sound pressure level detection unit 2041.

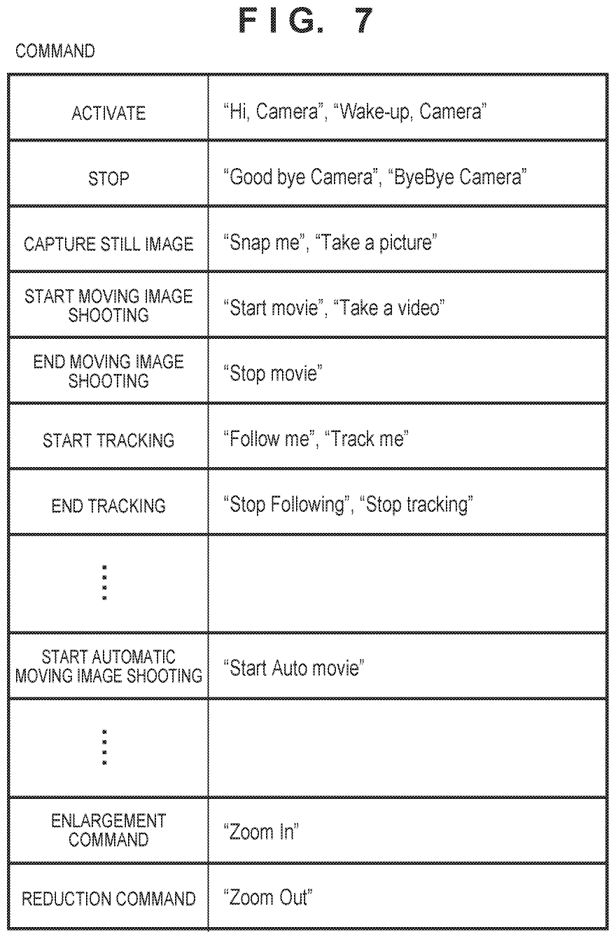

The command memory 2046 is constituted by a nonvolatile memory, and information regarding voice commands recognized by the image capturing apparatus is pre-stored (registered) therein. Although the details will be described later, the types of voice commands to be stored in the command memory 2046 are as shown in FIG. 7, for example. The information regarding a plurality of types of commands including an “activation command” is stored in the command memory 2046.

The voice command recognition unit 2043 is one of the targets of power supply/cutoff by the power supply control unit 211 under the control of the central control unit 201. Note that the speech recognition itself is a known technique, and therefore the description thereof is omitted here. The voice command recognition unit 2043 performs processing for recognizing sound data stored in the voice memory 2042 by referring to the command memory 2046. Also, the voice command recognition unit 2043 determines whether or not the sound data obtained by sound collection performed by the mic 104a is a voice command, and also determines which of the registered voice commands matches the sound data. Also, the voice command recognition unit 2043, upon detecting sound data that matches one of the voice commands stored in the command memory 2046, supplies information indicating which of the commands has been determined and the start and end addresses (timings) of the sound data, of the sound data stored in the voice memory 2042, that is used to determine the voice command to the central control unit 201.

The sound direction detection unit 2044 is one of the targets of power supply/cutoff by the power supply control unit 211 under the control of the central control unit 201. Also, the sound direction detection unit 2044 periodically performs processing for detecting the direction in which a sound source is present based on sound data from the four mics 104a to 104d. The sound direction detection unit 2044 includes an internal buffer memory 2044a, and stores information indicating the detected sound source direction in the buffer memory 2044a. Note that the cycle (e.g., 16 kHz) at which the sound direction detection unit 2044 performs the sound direction detection processing may be sufficiently longer than the sampling cycle of the mic 104a. Note that the buffer memory 2044a is assumed to have a capacity sufficient for storing sound direction information for a duration that is the same as the duration of sound data that can be stored in the voice memory 2042.

The moving image sound processing unit 2045 is one of the targets of power supply/cutoff by the power supply control unit 211 under the control of the central control unit 201. The moving image sound processing unit 2045 receives two pieces of sound data from the mics 103a and 104b, of the four mics, as stereo sound data, and performs thereon sound processing for moving image sound such as various types of filtering processing, wind cut, stereo sense enhancement, driving sound removal, ALC (Auto Level Control), and compression processing. Although the details will be made clear from a description given later, in the present embodiment, the mic 104a functions as an L channel mic, of a stereo mic, and the mic 104b functions as an R channel mic.

Note that, in FIG. 2, the minimum number of connections, with respect to the four mics, between the mics of the sound input unit 104 and the blocks included in the sound signal processing unit 204 are illustrated considering the power consumption and the circuit configuration. However, the configuration may also be such that the plurality of microphones are shared for use by the blocks included in the sound signal processing unit 204 to the extent permitted by as the power and the circuit configuration. Also, in the present embodiment, the mic 104a is connected as a reference mic, but any mic may be a reference mic.

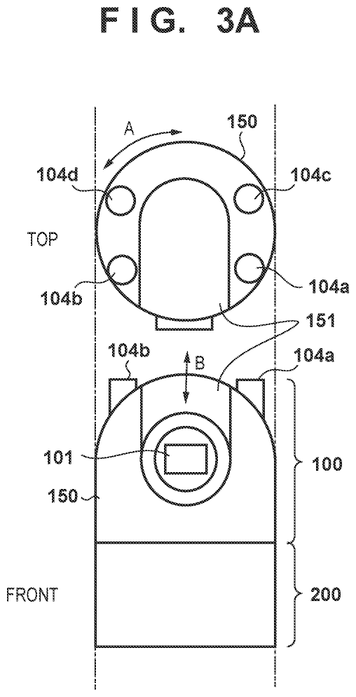

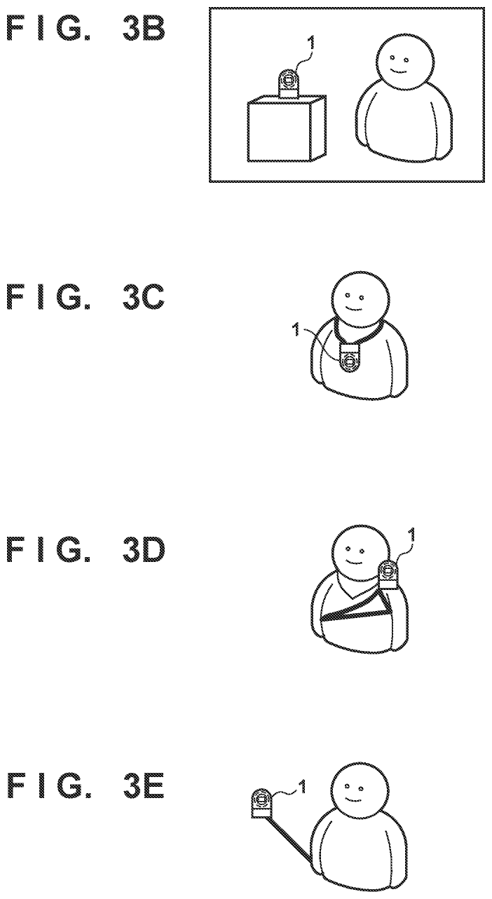

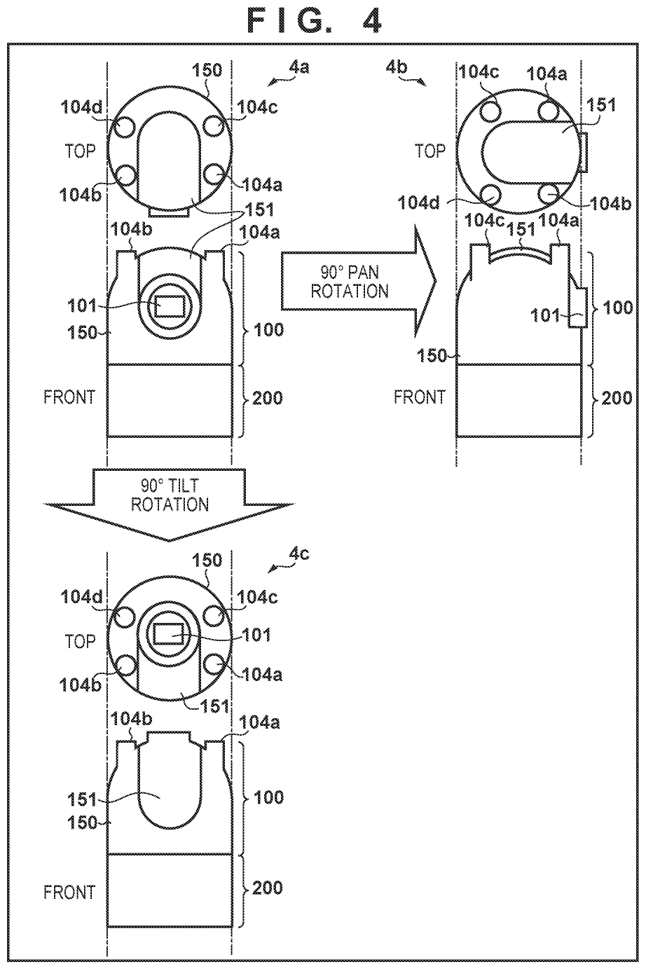

The external view and examples of use of the image capturing apparatus 1 will be described with reference to FIGS. 3A to 3E. FIG. 3A illustrates a top view and a front view of the external appearance of the image capturing apparatus 1 according to the present embodiment. The movable image capturing unit 100 of the image capturing apparatus 1 has a substantially hemispherical shape, and includes a first casing 150 that includes a cut-out window in a range from −20 degrees to 90 degrees, which indicates a vertical direction, where the horizontal direction is 0 degrees, and is pivotable over 360 degrees in a horizontal plane indicated by an arrow A shown in the diagram. Also, the movable image capturing unit 100 includes a second casing 151 that can pivot along the cut-out window together with the lens unit 101 and the image capturing unit 102 in a range from the horizontal direction to the vertical direction as shown by an arrow B shown in the diagram. Here, the pivoting operation of the first casing 150 shown by the arrow A corresponds to a panning operation, and the pivoting operation of the second casing 151 shown by the arrow B corresponds to a tilting operation, and these operations are realized by driving the driving units 11 to 13. Note that the tiltable range of the image capturing apparatus in the present embodiment is assumed to be the range from −20 degrees to +90 degrees, as described above.

The mics 104a and 104b are arranged at positions on a front side so as to sandwich the cut-out window of the first casing 150. Also, the mics 104c and 104d are provided on a rear side of the first casing 150. As is understood from the illustration, even if the panning operation of the first casing 150 is performed in any direction along the arrow A in a state in which the second casing 152 is fixed, the relative positions of the mics 104a and 104b relative to the lens unit 101 and the image capturing unit 102 will not change. That is, the mic 104a is always positioned on a left side relative to an image capturing direction of the image capturing unit 102, and the mic 104b is always positioned on a right side. Therefore, a fixed relationship can be kept between the space represented by an image obtained by capturing performed by the image capturing unit 102 and the field of sound acquired by the mics 104a and 104b.

Note that the four mics 104a, 104b, 104c, and 104d in the present embodiment are arranged at positions of the vertices of a rectangle in a top view of the image capturing apparatus 1, as shown in FIG. 3A. Also, these four mics are assumed to be positioned on one horizontal plane in FIG. 3A, but small positional shifts are allowed.

The distance between the mic 104a and the mic 104b is larger than the distance between the mics 104a and 104c. Note that the distances between adjacent mics are desirably in a range from about 10 mm to 30 mm. Also, in the present embodiment, the number of microphones is four, but the number of microphones may be three or more as long as the condition that the mics are not arranged on a straight line is satisfied. Also, the arrangement positions of the mics 104a to 104d shown in FIG. 3A are exemplary, and the arrangement method may be appropriately changed depending on mechanical restrictions and design restrictions.

FIGS. 3B to 3E illustrate use modes of the image capturing apparatus 1 in the present embodiment. FIG. 3B shows a case where the image capturing apparatus 1 is placed on a desk or the like, and the photographer himself/herself and the subjects around the photographer are shooting targets. FIG. 3C shows an exemplary case where the image capturing apparatus 1 is hung from the neck of the photographer, and the subjects in front of the photographer are shooting targets when he/she moves. FIG. 3D shows an exemplary use case where the image capturing apparatus 1 is fixed to the shoulder of the photographer, and the surrounding subjects on front, rear, and right sides are shooting targets, in the illustrated case. Also, FIG. 3E shows an exemplary use case where the image capturing apparatus 1 is fixed to an end of a stick held by the user, with the aim of moving the image capturing apparatus 1 to a shooting position (high position, position that cannot be reached by a hand) desired by the user and performing shooting.

The panning and tilting operations of the image capturing apparatus 1 of the present embodiment will be described in further detail with reference to FIG. 4. Here, the description will be made assuming an exemplary use case where the image capturing apparatus 1 is placed to stand as shown in FIG. 3B, but the same can apply to the other use cases.

4a in FIG. 4 denotes a state in which the lens unit 101 is directed in a horizontal direction. The state denoted by 4a in FIG. 4 is defined as an initial state, and when the first casing 150 performs a panning operation of 90 degrees in a counter-clockwise direction as viewed from above, the state denoted by 4b in FIG. 4 is entered. On the other hand, when the second casing 151 performs a tilting operation of 90 degrees from the initial state denoted by 4a in FIG. 4, the state denoted by 4c in FIG. 4 is entered. The pivoting of the first casing 150 and the second casing 151 is realized by vibrations of the driving units 11 to 13 that are driven by the pivoting control unit 213, as described above.

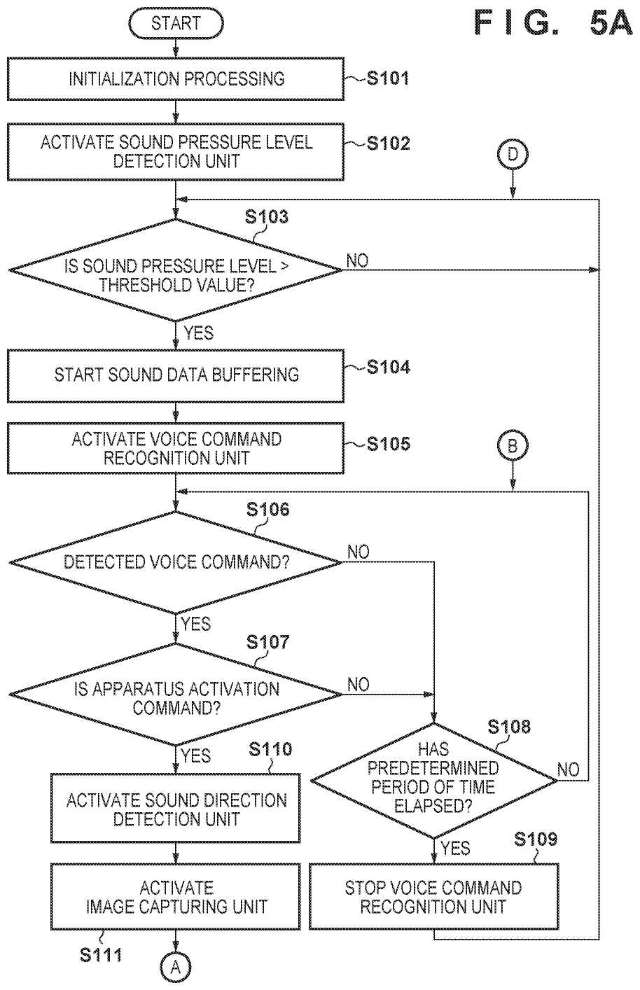

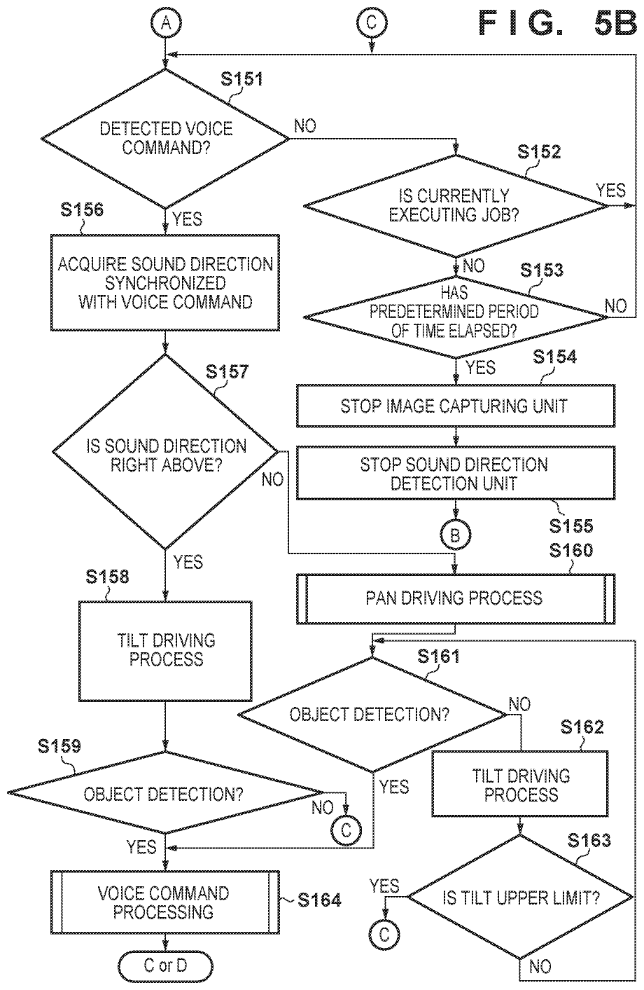

Next, the procedure of processing performed by the central control unit 201 of the image capturing apparatus 1 will be described following the flowcharts shown in FIGS. 5A and 5B. The processing shown in FIGS. 5A and 5B illustrate the processing performed by the central control unit 201 when the main power supply of the image capturing apparatus 1 is turned on or the image capturing apparatus 1 is reset.

The central control unit 201 performs initialization processing of the image capturing apparatus 1 in step S101. In this initialization processing, the central control unit 201 determines the current directional component in a horizontal plane of the image capturing direction of the image capturing unit 102 in the movable image capturing unit 100 as a reference angle (0 degrees) of the panning operation.

Hereinafter, the component in the horizontal plane of the image capturing direction after a panning operation of the movable image capturing unit 100 is performed is represented by a relative angle from this reference angle. Also, the component in the horizontal plane of the sound source direction detected by the sound direction detection unit 2044 is also represented by a relative angle with respect to the reference angle. Also, although the details will be described later, the sound direction detection unit 2044 also performs determination as to whether or not a sound source is present in a direction of right above the image capturing apparatus 1 (axial direction of the rotation axis of a panning operation).

Note that, at this stage, power to the voice memory 2042, the sound direction detection unit 2044, the moving image sound processing unit 2045, and the mics 104b to 104d is cut off.

Upon the initialization processing being ended, the central control unit 201 starts supplying power to the sound pressure level detection unit 2041 and the mic 104a by controlling the power supply control unit 211, in step S102. As a result, the sound pressure level detection unit 2041 executes sound pressure detection processing based on the sound data obtained by sampling performed by the mic 104a, and upon detecting sound data indicating a sound pressure level exceeding a preset threshold value, notifies the central control unit of this fact. Note that the threshold value is set to 60 dB SPL (Sound Pressure Level), for example, but the threshold value may be changed by the image capturing apparatus 1 in accordance with the environment or the like, or sound components in a necessary frequency band may be focused on.

The central control unit 201 waits for, in step S103, the sound pressure level detection unit 2041 to detect sound data indicating a sound pressure exceeding the threshold value. When sound data indicating a sound pressure exceeding the threshold value is detected, in step S104, the sound memory 2042 starts processing for receiving and storing the sound data from the mic 104a.

Also, in step S105, the central control unit 201 starts supplying power to the voice command recognition unit 2043 by controlling the power supply control unit 211. As a result, the voice command recognition unit 2043 starts processing for recognizing the sound data that is stored in the voice memory 2042 with reference to the command memory 2046. Also, the voice command recognition unit 2043 performs processing for recognizing the sound data stored in the voice memory 2042, and upon recognizing a voice command that matches one of the voice commands in the command memory 2046, notifies the central control unit 201 of information including information for specifying the recognized voice command and information regarding the start and end addresses (or timings) of the sound data, in the voice memory 2042, that is used to determine the recognized voice command.

In step S106, the central control unit 201 determines whether or not information indicating that a voice command has been recognized has been received from the voice command recognition unit 2043. If not, the central control unit 201 advances the processing to step S108, and determines whether or not the time elapsed from activation of the voice command recognition unit 2043 has exceeded a preset threshold value. Also, the central control unit 201 waits for the voice command recognition unit 2043 to recognize a voice command as long as the time elapsed is a threshold value or less. Then, if the voice command recognition unit 2043 has not recognized a voice command when the time indicated by the threshold value has elapsed, the central control unit 201 advances the processing to step S109. In step S109, the central control unit 201 cuts off power to the voice command recognition unit 2043 by controlling the power supply control unit 211. Then, the central control unit 201 returns the processing to step S103.

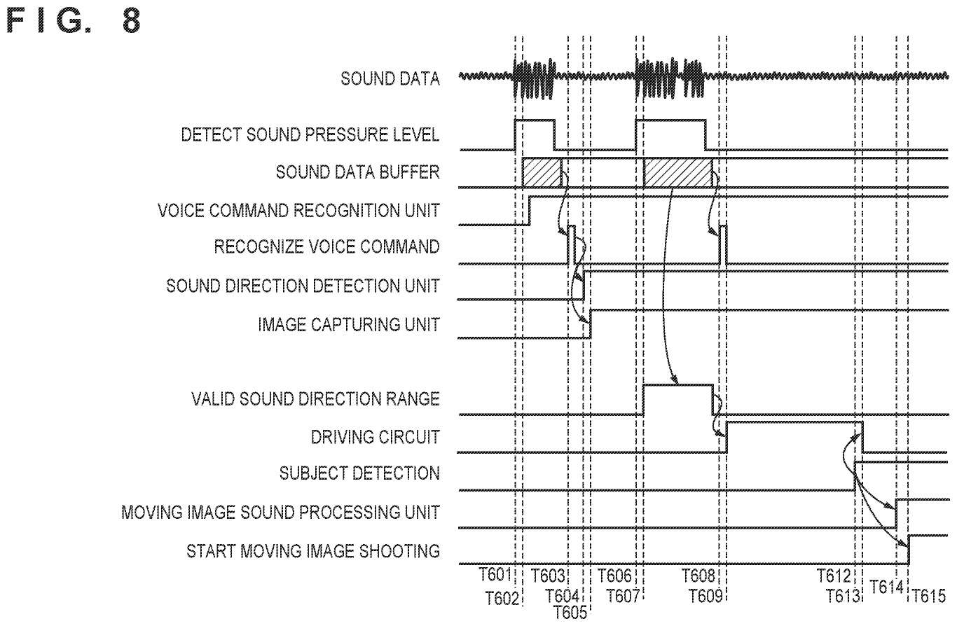

On the other hand, the central control unit 201, upon receiving information indicating that a voice command has been recognized from the voice command recognition unit 2043, advances the processing to step S107. In step S107, the central control unit 201 determines whether or not the recognized voice command corresponds to an activation command shown in FIG. 8. Also, the central control unit 201, upon determining that the recognized voice command is a command other than the activation command, advances the processing to step S108. Also, if the recognized voice command is the activation command, the central control unit 201 advances the processing from step S107 to step S110.

In step S110, the central control unit 201 starts supplying power to the sound direction detection unit 2044 and the mics 104b to 104d by controlling the power supply control unit 211. As a result, the sound direction detection unit 2044 starts processing for detecting the sound source direction based on the sound data from the four mics 104a to 104d at the same point in time. The processing for detecting the sound source direction is performed at a predetermined cycle. Also, the sound direction detection unit 2044 stores sound direction information indicating the detected sound direction in the internal buffer memory 2044a. Here, the sound direction detection unit 2044 stores the sound direction information in the buffer memory 2044a such that the timing of the sound data used for determination can be associated with a timing of the sound data stored in the sound memory 2042. Typically, the sound direction and the addresses of sound data in the sound memory 2042 may be stored in the buffer memory 2044a. Note that the sound direction information is information indicating an angle, in the horizontal plane, representing the difference of the sound source direction from the reference angle described above. Also, although the details will be described later, when the sound source is positioned right above the image capturing apparatus 1, information indicating that the sound source is in the direction of right above is set to the sound direction information.

In step S111, the central control unit 201 starts supplying power to the image capturing unit 102 and the lens actuator control unit 103 by controlling the power supply control unit 211. As a result, the movable image capturing unit 100 starts functioning as an image capturing apparatus.

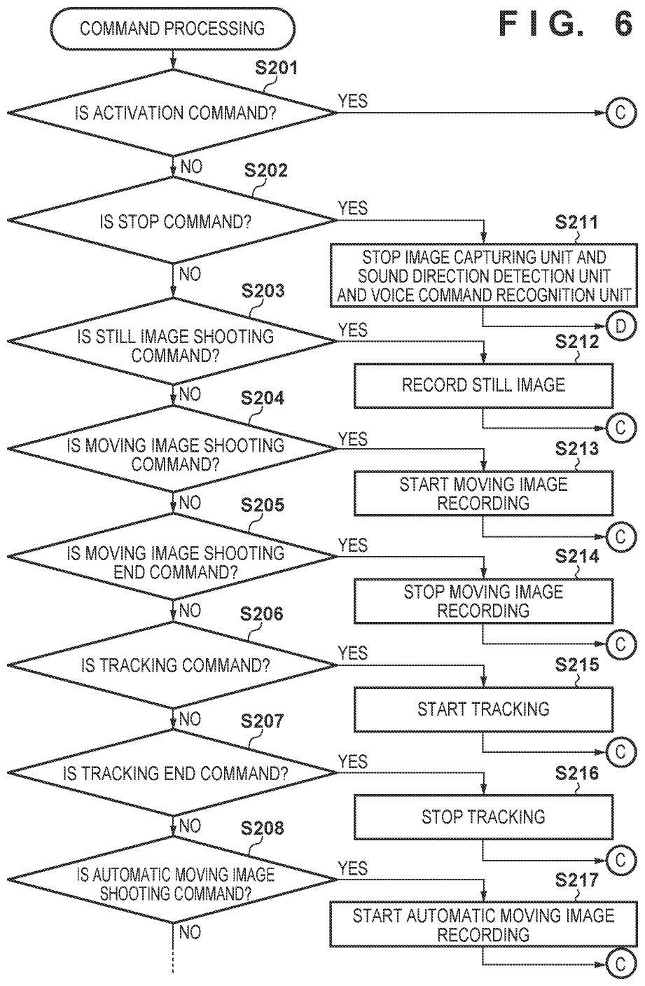

Next, in step S151, the central control unit 201 determines whether or not information indicating that a new voice command has been recognized is received from the voice command recognition unit 2043. If not, the central control unit 201 advances the processing to step S152, and determines whether or not a job in accordance with the instruction from the user is currently being executed. Although the details will be made clear by the description of the flowchart in FIG. 6, moving image shooting and recording, tracking processing, and the like correspond to jobs. Here, the description is continued assuming that such a job is not being executed.

In step S153, it is determined whether or not the time elapsed from when the previous voice command was recognized exceeds a preset threshold value. If not, the central control unit 201 returns the processing to step S151 and waits for a voice command to be recognized. Then, if a job is not being executed, and a new voice command has not been recognized even though the time elapsed from when the previous voice command was recognized exceeds the threshold value, the central control unit 201 advances the processing to step S154. In step S154, the central control unit 201 cuts off power supply to the image capturing unit 102 and the lens actuator control unit 103 by controlling the power supply control unit 211. Also, in step S155, the central control unit 201 also cuts off power supply to the sound direction detection unit 2044 by controlling the power supply control unit 211, and returns the processing to step S106.

It is assumed that the central control unit 201 has received information indicating that a new voice command has been received from the voice command recognition unit 2043. In this case, the voice command recognition unit 2043 advances the processing from step S151 to step S156.

The central control unit 201 in the present embodiment performs, before executing a job in accordance with a recognized voice command, processing for bringing a person who spoke the voice command into an angle of view of the image capturing unit 102 of the movable image capturing unit 100. Then, the central control unit 201 executes the job based on the recognized voice command in a state in which the person is in the angle of view of the image capturing unit 102.

In order to realize the technique described above, in step S156, the central control unit 201 acquires sound direction information synchronized with the voice command recognized by the voice command recognition unit 2043 from the buffer memory 2044a of the sound direction detection unit 2044. The voice command recognition unit 2043, upon recognizing a voice command, notifies the central control unit 201 of the two addresses of the start and end of the voice command in the voice memory 2042, as described above. Then, the central control unit 201 acquires sound direction information detected in the period indicated by the two addresses from the buffer memory 2044a. There may be a case where a plurality of pieces of sound direction information are present in the period indicated by the two addresses. In this case, the central control unit 201 acquires the temporally most recent sound direction information from the buffer memory 2044a. This is because the probability that the temporally most recent sound direction information represents the current position of the person who spoke the voice command is high.

In step S157, the central control unit 201 determines whether or not the sound source direction indicated by the acquired sound information is the direction of right above the image capturing apparatus. Note that the details of the determination as to whether or not the sound direction is the direction of right above the image capturing apparatus will be described later.

If the sound source is present in the direction of right above the image capturing apparatus 1, the central control unit 201 advances the processing to step S158. In step S158, the central control unit 201 causes, by controlling the pivoting control unit 213, the second casing 151 of the movable image capturing unit 100 to pivot such that the image capturing direction of the lens unit 101 and the image capturing unit 102 is the right-above direction, as denoted by 4c in FIG. 4. When the image capturing direction of the image capturing unit 102 is set to the right-above direction, in step S159, the central control unit 201 receives a captured image from the video signal processing unit 203, and determines whether or not an object (face of a person), which can be a sound source, is present in the captured image. If not, the central control unit 201 returns the processing to step S151. On the other hand, if an object is present in the captured image, the central control unit 201 advances the processing to step S164, and executes a job corresponding to the already recognized voice command. Note that the details of processing in step S164 will be described later using FIG. 6.

In step S157, the central control unit 201, upon determining that the direction indicated by the sound information is a direction other than the right-above direction, advances the processing to step S160. In step S160, the central control unit 201 performs a panning operation of the movable image capturing unit 100, by controlling the pivoting control unit 213, such that the current angle in the horizontal plane of the image capturing unit 102 matches the angle in the horizontal plane indicated by the sound information. Then, in step S161, the central control unit 201 receives a captured image from the video signal processing unit 203, and determines whether or not an object (face), which can be a sound source, is present in the captured image. If not, the central control unit 201 advances the processing to step S162, and performs a tilting operation of the movable image capturing unit 100 by a preset angle toward a target tilt angle by controlling the pivoting control unit 213. Then, in step S163, the central control unit 201 determines whether or not the tilt angle of the image capturing direction of the image capturing unit 102 has reached an upper limit of the tilting operation (90 degrees from the horizontal direction, in the present embodiment). If not, the central control unit 201 returns the processing to step S161. In this way, the central control unit 201 determines whether or not an object (face), which can be a sound source, is present in the captured image from the video signal processing unit 203 while performing the tilting operation. Then, if an object has not been detected even if the tilt angle of the image capturing direction of the image capturing unit 102 has reached the tilting upper limit, the central control unit 201 returns the processing from step S163 to step S151. On the other hand, if an object is present in the captured image, the central control unit 201 advances the processing to step S164, and executes a job corresponding to the already recognized voice command.

Next, the details of processing in step S164 will be described based on the flowchart in FIG. 6 and a voice command table shown in FIG. 7. Pieces of voice pattern data corresponding to voice commands such as “Hi, Camera” shown in the voice command table in FIG. 7 are stored in the command memory 2046. Note that, several representative examples are shown in FIG. 7 as the voice commands, but the number thereof is not specifically limited. Also, it should be noted that the voice command in the following description is a voice command detected at the timing of step S151 in FIG. 5B.

First, in step S201, the central control unit 201 determines whether or not the voice command is an activation command.

The activation command is a voice command for causing the image capturing apparatus 1 to transition to a state in which image capturing is possible. The activation command is a command that is determined in step S107 in FIG. 5A, and is not a job relating to image capturing. Therefore, if the recognized voice command is the activation command, the central control unit 201 ignores the command and returns the processing to step S151.

In step S202, the central control unit 201 determines whether or not the voice command is a stop command. The stop command is a command for causing the state to transition from a state in which a series of image capturing is possible to a state of waiting for input of the activation command. Therefore, if the recognized voice command is the stop command, the central control unit 201 advances the processing to step S211. In step S211, the central control unit 201 cuts off power to the image capturing unit 102, the sound direction detection unit 2044, the voice command recognition unit 2043, the moving image sound processing unit 2045, the mics 104b to 104d, and the like that are already activated, by controlling the power supply control unit 211, and stops these units. Then, the central control unit 201 returns the processing to step S103 at the time of activation.

In step S203, the central control unit 201 determines whether or not the voice command is a still image shooting command. The still image shooting command is a command for requesting the image capturing apparatus 1 to execute a shooting/recording job of one still image. Therefore, the central control unit 201, upon determining that the voice command is the still image shooting command, advances the processing to step S212. In step S212, the central control unit 201 stores the one piece of still image data obtained by capturing performed by the image capturing unit 102 in the storage unit 206 as a JPEG file, for example. Note that the job of the still image shooting command is completed by performing shooting and recording of one still image, and therefore this job is not a determination target job in step S152 in FIG. 5B described above.

In step S204, the central control unit 201 determines whether or not the voice command is a moving image shooting command. The moving image shooting command is a command for requesting the image capturing apparatus 1 to capture and record a moving image. The central control unit 201, upon determining that the voice command is the moving image shooting command, advances the processing to step S213. In step S213, the central control unit 201 starts shooting and recording of a moving image by the image capturing unit 102, and returns the processing to step S151. In the present embodiment, the captured moving image is stored in the storage unit 206, but the captured moving image may be transmitted to a file server on a network via the external input/output terminal unit 208. The moving image shooting command is a command for causing capturing and recording of an moving image to continue, and therefore this job is a determination target job in step S152 in FIG. 5B described above.

In step S205, the central control unit 201 determines whether or not the voice command is a moving image shooting end command. If the voice command is the moving image shooting end command, and capturing/recording of a moving image is actually being performed, the central control unit 201 ends the recording (job). Then, the central control unit 201 returns the processing to step S151.

In step S206, the central control unit 201 determines whether or not the voice command is a tracking command. The tracking command is a command for requesting the image capturing apparatus 1 to cause the user to be continuously positioned in the image capturing direction of the image capturing unit 102. The central control unit 201, upon determining that the voice command is the tracking command, advances the processing to step S214. Then, in step S214, the central control unit 201 starts controlling the pivoting control unit 213 such that the object is continuously positioned at a central position of the video obtained by the video signal processing unit 203. Also, the central control unit 201 returns the processing to step S151. As a result, the movable image capturing unit 100 tracks the moving user by performing a panning operation or a tilting operation. Note that, although tracking of the user is performed, recording of the captured image is not performed. Also, while tracking is performed, the job is a determination target job in step S152 in FIG. 5B described above. Then, upon receiving a tracking end command, the central control unit 201 finally ends shooting and recording of the moving image. Note that jobs of the still image shooting command and moving image shooting command, for example, may be executed while tracking is performed.

In step S207, the central control unit 201 determines whether or not the voice command is the tracking end command. If the voice command is the tracking end command, and tracking is actually being performed, the central control unit 201 ends the tracking (job). Then, the central control unit 201 returns the processing to step S151.

In step S208, the central control unit 201 determines whether or not the voice command is an automatic moving image shooting command. The central control unit 201, upon determining that the voice command is the automatic moving image shooting command, advances the processing to step S217. In step S217, the central control unit 201 starts shooting and recording of a moving image by the image capturing unit 102, and returns the processing to step S151. The automatic moving image shooting command differs from the moving image shooting command described above in that, if the job of the automatic moving image shooting command is started, from this point in time, every time the user speaks, shooting/recording of a moving image is performed while the image capturing direction of the lens unit 101 is directed in the sound source direction of the voice. For example, in an environment of a meeting in which a plurality of speakers are present, a moving image is recorded while performing panning and tilting operations in order to, every time a speech is made, bring the speaker into the angle of view of the lens unit 101. Note that, in this case, free speech is permitted, and therefore there is no voice command for causing the job of the automatic moving image shooting command to end. It is assumed that this job is ended by operating a predetermined switch provided in the operation unit 205. Also, the central control unit 201 stops the voice command recognition unit 2043 while this job is being executed. Also, the central control unit 201 performs panning and tilting operations of the movable image capturing unit 104 with reference to sound direction information detected by the sound direction detection unit 2044 at the timing at which the sound pressure level detection unit 2041 has detected a sound pressure level exceeding the threshold value.

Note that, although not illustrated in FIG. 6, if the recognized voice command is an enlargement command, the central control unit 201 increases the current magnification by a preset value by controlling the lens actuator control unit 103. Also, if the recognized voice command is a reduction command, the central control unit 201 reduces the current magnification by a preset value by controlling the lens actuator control unit 103. Note that if the lens unit 101 is already at a telephoto end or a wide angle end, the enlargement ratio or the reduction ratio cannot be further increased, and therefore when such a voice command is made, the central control unit 201 ignores the voice command.

The description has been made above. Voice commands other than the voice commands described above are to be executed in steps after step S207, but the description thereof will be omitted here.

Here, an example of the sequence from when the main power supply is turned on in the image capturing apparatus 1 in the present embodiment will be described following the timing chart shown in FIG. 8.

When the main power supply of the image capturing apparatus 1 is turned on, the sound pressure level detection unit 2041 starts processing for detecting the sound pressure level of sound data from the mic 104a. It is assumed that a user starts speaking the activation command “Hi, Camera”, at timing T601. As a result, the sound pressure level detection unit 2041 detects a sound pressure exceeding the threshold value. Triggered by this detection, at timing T602, the voice memory 2042 starts storing sound data from the mic 104a, and the voice command recognition unit 2043 starts recognizing the voice command. When the user ends speaking of the activation command “Hi, Camera”, at timing T603, the voice command recognition unit 2043 recognizes the voice command, and specifies that the recognized voice command is the activation command.

At timing T603, the central control unit 201 starts power supply to the sound direction detection unit 2044 triggered by the recognition of the activation command. Also, the central control unit 201 also starts power supply to the image capturing unit 102 at timing T604.

It is assumed that the user starts saying “Movie start”, for example, at timing T606. In this case, the sound data at the timing of the start of the saying is stored in the voice memory 2042 in order from timing T607. Also, at timing T608, the voice command recognition unit 2043 recognizes the sound data as a voice command representing “Movie start”. The voice command recognition unit 2043 notifies the central control unit 201 of the start and end addresses of sound data representing “Movie start” in the voice memory 2042 and the recognition result. The central control unit 201 determines the range indicated by the received start and end addresses as a valid range. Also, the central control unit 201 extracts the latest sound direction information from the valid range in the buffer memory 2044a of the sound direction detection unit 2044, and at timing T609, starts panning and tilting operations of the movable image capturing unit 100 by controlling the pivoting control unit 213 based on the extracted information.

It is assumed that, at timing T612, a subject (object: face) is detected in an image captured by the image capturing unit 102 while the movable image capturing unit 100 is performing panning and tilting operations. The central control unit 201 stops the panning and tilting operations (timing T613). Also, at timing T614, the central control unit 201 supplies power to the moving image sound processing unit 2045 so as to enter a state in which stereo sound is collected by the mics 104a and 104b. Also, the central control unit 201 starts capturing and recording a moving image with sound, at timing T615.

Next, the processing for detecting the sound source direction performed by the sound direction detection unit 2044 in the present embodiment will be described. This processing is performed periodically and continuously after step S110 in FIG. 5A.

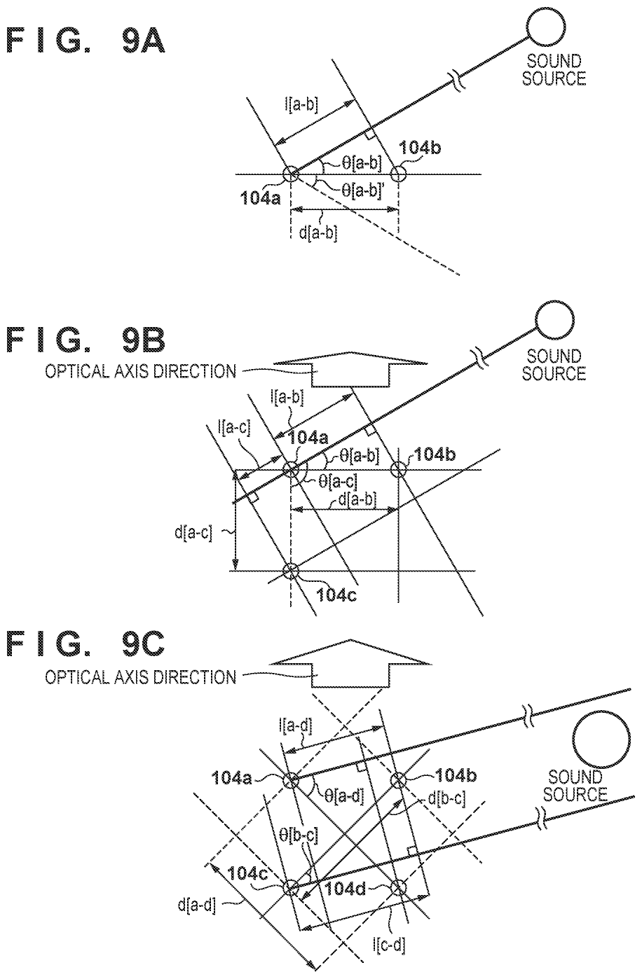

First, a simple sound direction detection using two mics, namely the mics 104a and 104b, will be described using FIG. 9A. In FIG. 9A, it is assumed that the mics 104a and 104b are arranged on a plane (on a virtual plane). The distance between the mics 104a and 104b is denoted by d[a−b]. It is assumed that the distance between the image capturing apparatus 1 and the sound source is sufficiently large relative to the distance d[a−b]. In this case, the delay time in sound between the mics 104a and 104b can be specified by comparing the sounds collected by the mics 104a and 104b.

The distance I[a−b] can be specified by multiplying the arrival delay time by the speed of sound (340 m/s in air). As a result, the sound source direction angle θ[a−b] can be specified using the following equation.

θ[a−b]=acos(I[a−b]/d[a−b])

However, the sound direction obtained by using two mics cannot be distinguished between the obtained sound source direction and θ[a−b]′. That is, which of the two directions cannot be specified.

Thus, the detection method of the sound source direction in the present embodiment will be described using FIGS. 9B and 9C as follows. Specifically, since there are two sound source directions that can be estimated using two mics, these two directions are treated as provisional directions. Also, a sound source direction is obtained using another two mics, and two provisional directions are obtained. Then, the direction that is common between these provisional directions is determined as the sound source direction to be obtained. Note that the upper direction in FIGS. 9B and 9C is assumed to be the image capturing direction of the movable image capturing unit 100. The image capturing direction of the movable image capturing unit 100 can also be rephrased as an optical axis direction (principal axis direction) of the lens unit 101.

FIG. 9B illustrates a method in which three mics are used. Description will be given using mics 104a, 104b, and 104c. In an arrangement as illustrated in FIG. 3A, the direction orthogonal to the direction in which the mics 104a and 104b are lined up is the image capturing direction of the lens unit 101.

As described with reference to FIG. 9A, the distance d[a−b] is known from the positions of the mics 104a and 104b, and therefore, if the distance I[a−b] can be specified from sound data, θ[a−b] can be specified. Moreover, since the distance d[a−c] between the mics 104a and 104c is known, the distance I[a−c] can also be specified from sound data, and θ[a−c] can be specified. If θ[a−b] and θ[a−c] can be calculated, the angle that is common between these angles on a two-dimensional plane (on a virtual plane) that is the same as the plane on which the mics 104a, 104b, and 104c are arranged can be determined as the accurate sound generation direction.

A method of determining the sound source direction using four mics will be described using FIG. 9C. Due to the arrangement of the mics 104a, 104b, 104c, and 104d shown in FIG. 3A, the direction orthogonal to the direction in which the mics 104a and 104b are lined up is the image capturing direction (optical axis direction) of the lens unit 101. When four mics are used, if two pairs, namely a pair of mics 104a and 104d and a pair of mics 104b and 104c that are each positioned on a diagonal line, the sound source direction can be accurately calculated.

Since the distance d[a−d] between the mics 104a and 104d is known, the distance I[a−d] can be specified from sound data, and θ[a−d] can also be specified.

Moreover, since the distance d[b−c] between the mics 104b and 104c is known, the distance I[b−c] can be specified from sound data, and θ[b−c] can also be specified.

Therefore, once θ[a−d] and θ[b−c] are known, sound generation direction can be accurately detected on a two-dimensional plane that is the same as the plane on which the mics are arranged.

Moreover, the detection accuracy of the angle of direction can also be improved by increasing the number of detection angles such as θ[a−b] and θ[c−d].

In order to perform the processing described above, the mics 104a and 104b and the mics 104c and 104d are arranged at four vertices of a rectangle, as shown in FIG. 3A. Note that the number of mics need not be four, and may be three as long as the three mics are not lined up on a straight line.

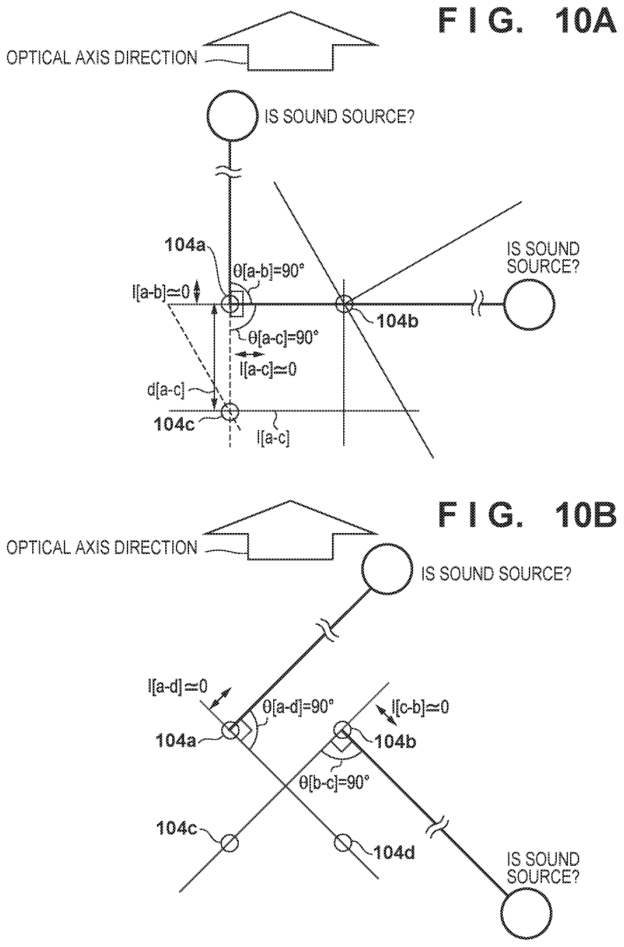

The demerit of the method described above is that only a sound direction on the same two-dimensional plane can be detected. Therefore, when the sound source is positioned right above the image capturing apparatus 1, the direction cannot be detected, and the direction is uncertain. Therefore, next, the principle of determination, in the sound direction detection unit 2044, as to whether or not the direction in which a sound source is present is the right-above direction will be described with reference to FIGS. 10A and 10B.

FIG. 10A illustrates a method using three mics. Description will be given using the mics 104a, 104b, and 104c. When the mics are arranged as shown in FIG. 3A, the direction orthogonal to the direction in which the mics 104a and 104b are lined up is the image capturing direction (optical axis direction) of the lens unit 101. The direction in which the mics 104a and 104b are lined up is the direction of a straight line that connects the central point of the mic 104a and the central point of the mic 104b.

A case where sound enters along a straight line that vertically intersects the plane on which the sound input unit 104 is arranged, that is, from above, will be described.

Here, when a sound source is positioned right above the image capturing apparatus 1, it can be regarded that the mics 104a and 104b are at an equal distance from the sound source. That is, there is no difference in arrival time of sound from the sound source between the two mics 104a and 104b. Therefore, it can be recognized that the sound source is present in a direction that vertically intersects the straight line connecting the mics 104a and 104b.

Moreover, it can be similarly regarded that the mics 104a and 104c are at an equal distance from the sound source, and therefore there is also no difference in arrival time of sound from the sound source between the two mics 104a and 104c. Therefore, it can be recognized that the sound source is present in a direction that vertically intersects the straight line connecting the mics 104a and 104c.

That is, when the absolute value of difference in time of sound detected by the mics 104a and 104b is denoted by ΔT1, the absolute value of difference in time of sound detected by the mics 104a and 104c is denoted by ΔT2, and a relationship with a preset sufficiently small threshold value c satisfies the following condition, it can be determined that the sound source is positioned right above the image capturing apparatus 1.

condition: ΔT1<ε and ΔT2<ε

The detection method of a sound source positioned right above the image capturing apparatus 1 using the four mics 104a, 104b, 104c, and 104d will be described with reference to FIG. 10B. As shown in FIG. 3A, the pair of mics 104a and 104d and the pair of mics 104b and 104c will be considered.

When a sound source is present right above the image capturing apparatus 1, the mics 104a and 104d are at the equal distance from the sound source, the absolute value ΔT3 of the difference in time of sound detected by these mics 104a and 104d is zero or an extremely small value. That is, it is recognized that the sound source is present in a direction that vertically intersects the straight line connecting the mics 104a and 104d.

Moreover, because the mics 104b and 104c are also at an equal distance from the sound source, the absolute value ΔT4 of the difference in time of sound detected by these mics 104b and 104c is also zero or an extremely small value. That is, it is recognized that the sound source is present in a direction that vertically intersects the straight line connecting the mics 104b and 104c. Therefore, if the following condition is satisfied, it can be determined that the sound source is positioned right above the image capturing apparatus 1.

condition: ΔT3<ε and ΔT4<ε

As described above, the absolute values of differences in time-of-arrival of sound are obtained with respect to two pairs of mics out of three or more mics, and when the two absolute values are both less than or equal to the sufficiently small threshold value, it can be determined that the direction in which the sound source is present is the right-above direction. Note that, when two pairs are determined, any combination is allowed as long as the directions of the two pairs are not parallel to each other.

The first embodiment has been described above. According to the embodiment described above, it is determined that a subject that spoke a voice command is present in a direction indicated by the sound direction information, of pieces of sound direction information that are sequentially detected by the sound direction detection unit 2044, in a period indicated by the start and end of the sound data with respect to which the voice command recognition unit 2043 has recognized the voice command. As a result, an object other than the person (face thereof) who spoke a voice command is kept from being erroneously recognized as the subject. Also, the job intended by a person who spoke a voice command can be executed.

Moreover, as described in the above embodiment, power to each of the mics 104a to 104d and the elements that constitute the sound signal processing unit 204 is supplied after entering a stage at which the element is actually used, under the control of the central control unit 201, and therefore power consumption can be suppressed compared with a case where all of the constituent elements are in operable states.

Next, a specific use mode will be described based on the description of the above embodiment. As shown in FIGS. 3A to 3E, there are various use modes of the image capturing apparatus 1 in the present embodiment.

Here, a case where the image capturing apparatus 1 is hung from the neck of a user, as shown in FIG. 3C, is considered, for example. In this case, it can be easily understood that, if the image capturing direction (optical axis direction) of the lens unit 101 is directed toward the body of the user, unnecessary images will be captured. Therefore, it is desirable that the image capturing direction (optical axis direction) of the lens unit 101 is always directed forward of the user. In this case, it is highly possible that the mics 104c and 104d, of the four mics, will brush against the body of the user, as shown in FIG. 3A. That is, the likelihood that the mics 104c and 104d will collect sound of rubbing against the user's clothes increases, and the sound direction detection by the sound direction detection unit 2044 using the four mics is disrupted. Therefore, in the present embodiment, in a use mode in which the image capturing apparatus 1 is hung from the neck of a user, the central control unit 201 cuts off power to the mics 104c and 104d, and instructs the sound direction detection unit 2044 to perform sound direction detection using only the two mics of mics 104a and 104b. In this case, the problem that two sound source directions are detected when the sound source direction is obtained using only two mics, which has been described with reference to FIG. 9A, will not occur. This is because the sound source direction can be regarded as being at least in a range forward of the user. That is, since only two mics of mics 104a and 104b are used, the sound direction detection unit 2044 detects two sound directions mathematically, but detects the sound source direction directed forward of the user as the valid sound source direction. Note that the detection of direction in which the body of a user is present is performed as follows, for example. After determining that the image capturing apparatus 1 is hung from the neck of the user, a panning operation of 360 degrees (one round) is performed, and a range of appropriate angles (e.g., 180 degrees, in FIG. 3C) centered about a direction in which the measured distance is shortest (direction of the chest of the user, in FIG. 3C) may be determined as the direction in which the user is present. Also, the central control unit 201 saves the determined direction as a reference direction in the storage unit 206.

Next, a case where the image capturing apparatus 1 is attached to the shoulder of a user, as shown in FIG. 3D, is also considered. In this case, one of the four mics is positioned close to the user's head, and it is highly likely that that mic will come into contact with the user's head or clothes. Therefore, in this case, the mic, of the four mics, that is close to the user's head will not be used (power is cut off) when the sound direction is detected, and the sound source direction is detected using the remaining three mics. Once the image capturing apparatus 1 is attached (fixed) to the user's shoulder, the relative direction of the user's head relative to the image capturing apparatus 1 will not change regardless of the movement of the user. Therefore, the central control unit 201 saves this direction in the storage unit 206 as the direction of the user's head. Also, the central control unit 201 will not use (cuts off power to) one mic, of the four mics, on a side close to the user's head when a direction is to be detected, based on the stored direction and the image capturing direction (optical axis direction) of the lens unit 101, and configures a setting such that the sound direction detection unit 2044 will perform direction detection using the remaining three mics. Note that the detection of the direction in which the user's head is present is performed as follows, for example. After determining that the image capturing apparatus 1 is attached to the shoulder, a panning operation of 360 degrees is performed, and a range of appropriate angles (e.g., 90 degrees) centered about a direction in which the measured distance is shortest may be determined as the direction in which the user is present. Also, the central control unit 201 saves the direction in which the measured distance is shortest (direction of user's head) as a reference direction in the storage unit 206.

Also, in the case of use modes illustrated in FIGS. 3B and 3E, the sound direction detection unit 2044 may perform sound direction detection using the four mics.

Here, which of the use modes illustrated in FIGS. 3B to 3E will be used is set by the user through the operation unit 205 of the support unit 200. Note that, when the user has set the automatic detection mode through the operation unit 205, automatic detection of the use mode is performed by the central control unit 201. In the following, the processing of the automatic detection to be performed by the central control unit 201 when the automatic detection mode is set will be described.

The fact that the position detection unit 212 in the present embodiment includes constituent elements for detecting the movement of the image capturing apparatus 1 such as a gyroscope sensor, an acceleration sensor, and a GPS sensor has already been described. Therefore, after the main power supply of the image capturing apparatus 1 is turned on and the initialization processing in step S101 in FIG. 5A is performed, the sound direction detection unit 2044 performs sound direction detection assuming that the image capturing apparatus 1 is basically in a state illustrated in FIG. 3B, that is, in a fixed state.

On the other hand, after the initialization processing in step S101 in FIG. 5A, if the user holds the image capturing apparatus 1, and performs an operation to determine its use mode, naturally, the position detection unit 212 detects a change in position that is larger than a threshold value using the sensors such as the acceleration sensor and the gyroscope. Also, the timing at which the user performs this operation is assumed to be a timing at which the user turns on the main power supply of the image capturing apparatus 1. For example, if at least one of the sensors has detected a change that is larger than a threshold value in a preset period after the initialization processing, the position detection unit 212 estimates that the user is performing an operation for installing the image capturing apparatus 1, and transmits an interrupt signal to the central control unit 201.

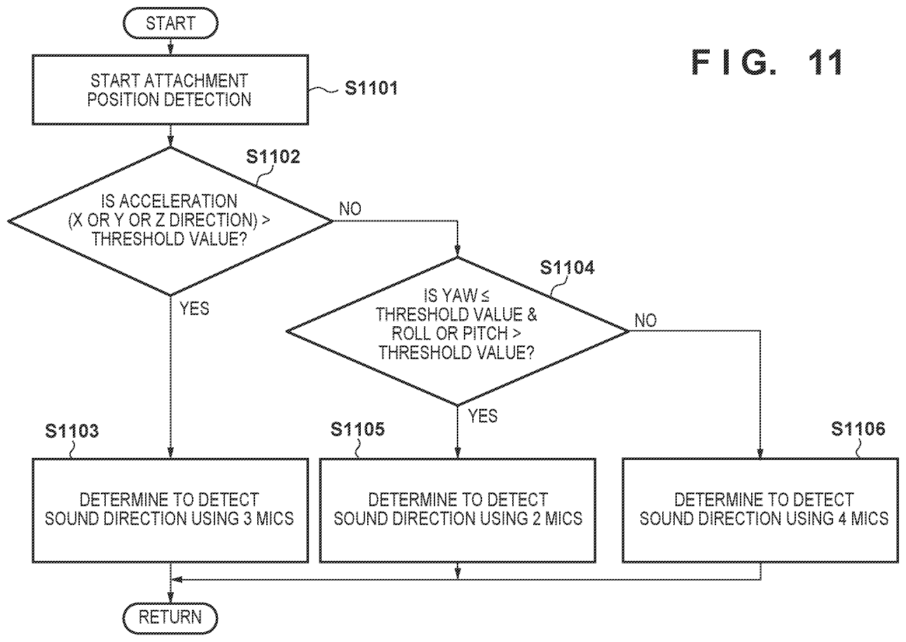

The flowchart shown in FIG. 11 illustrates this interrupt processing (processing for detecting the installation position of the image capturing apparatus 1). In the following, the processing to be performed by the central control unit 201 will be described with reference to FIG. 11.

First, in step S1101, the central control unit 201 saves data that the sensors included in the position detection unit 212 output during a preset period (saving period) in the storage unit 206. The saving period is desirably a period that is sufficient for the user to complete the operation regarding the use mode (e.g., one minute).

Upon the saving period having elapsed, the central control unit 201 performs determination of the installation position of the image capturing apparatus 1 based on the saved data, and determines the sound direction detection method to be used by the sound direction detection unit 2044, as describe below. Note that, in the following description, it is assumed that the plane indicated by the x and y axes represents a plane vertical to the rotation axis of the panning operation of the image capturing apparatus 1, and the z axis represents the axial direction of the rotation axis of the panning operation of the image capturing apparatus 1.

In the case where the user attaches the image capturing apparatus 1 to his/her shoulder (case illustrated in FIG. 3D), there is a tendency that the movement amount in one of the x, y, and z-axis directions is greatly larger than that in the cases illustrated in FIGS. 3B, 3C, and 3E. Therefore, in step S1102, the central control unit 201 determines whether or not any of the saved accelerations along the x, y, and z axes exceeds a preset threshold value. If an angular velocity exceeding the threshold value is present, the central control unit 201 estimates that the image capturing apparatus 1 is attached to the user's shoulder, and in step S1103, configures a setting such that the sound direction detection unit 2044 performs detection of the sound source direction following the sound direction detection method (or a rule) in which the remaining three mics excluding one mic that is close to the user's head are used, and ends this processing.

In step S1102, if none of the accelerations along the x, y, and z axes exceed the threshold value, the central control unit 201 advances the processing to step S1104.

There is a tendency that the movement amounts in the x, y, and z directions when the image capturing apparatus 1 is hung from the neck is smaller than those when the image capturing apparatus 1 is attached to the shoulder. Also, in order to hang the image capturing apparatus 1 from the neck, an operation of turning the image capturing apparatus 1 upside down is needed, as illustrated in FIG. 3C. Therefore, when an operation of hanging the image capturing apparatus 1 from the neck is performed, there is a tendency that the angular velocity with respect to a certain specific axis will increase. Also, the rotation about the z axis is small.

Therefore, in step S1104, the central control unit 201 detects angular velocities along the x, y, and z axes, and compares them with threshold values. Specifically, the central control unit 201 determines whether the angular velocity (yaw) with respect to z axis is less than or equal to a preset threshold value, and the angular velocity (roll, pitch) with respect to the x or y axis is larger than a preset threshold value (since this threshold is different from the former threshold, the article “the” is not used).

If this condition is satisfied, the central control unit 201 estimates that the image capturing apparatus 1 is hung from the user's neck. Also, the central control unit 201 configures a setting such that the sound direction detection unit 2044 performs sound source direction detection using only the two mics of mics 104a and 104b out of the four mics following a sound direction detection method in which the direction opposite to the side of the mics 104c and 104d is regarded as the direction in which a sound source is present, and ends this processing (where the term “using only the two mics” should be directed to “sound source direction detection”).

On the other hand, if it is determined that, in step S1104, the angular velocity in the yaw direction is larger than a threshold value, and the angular velocity of roll or pitch is less than or equal to a threshold value, the central control unit 201 regards, in step 1106, that the image capturing apparatus 1 has been fixed at an appropriate position by user's hand. Therefore, the central control unit 201 configures the setting, in step S1106, such that sound direction detection unit 2044 performs sound source direction detection following a sound direction detection method in which four mics are used, and ends this processing.

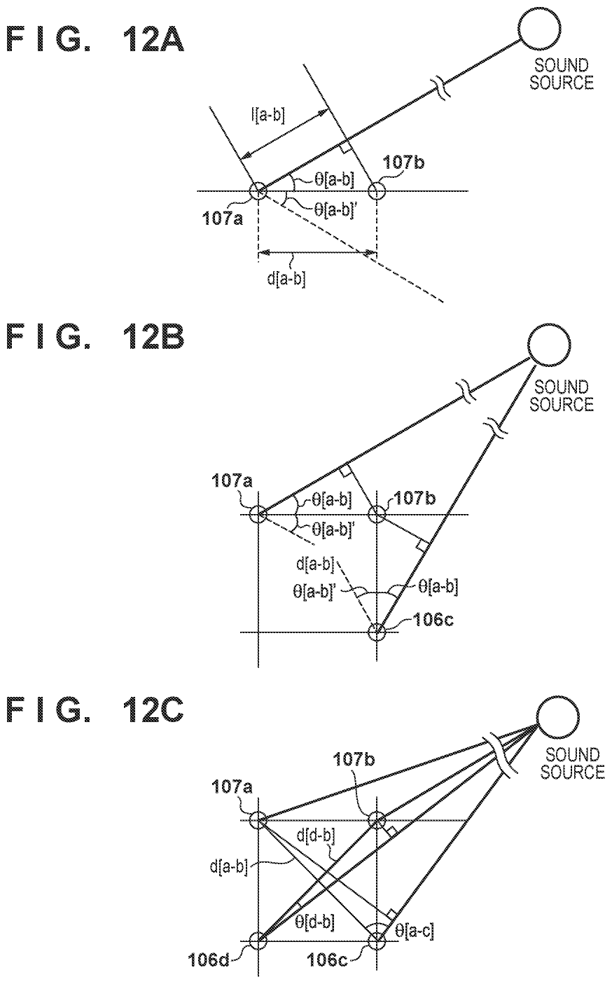

FIG. 12A is a diagram illustrating the sound direction detection method when the image capturing apparatus 1 is hung from the user's neck, and FIG. 12B is a diagram illustrating the sound direction detection method when the image capturing apparatus 1 is fixed to the user's shoulder. Also, FIG. 12C is a diagram illustrating the sound direction detection method when the image capturing apparatus 1 is fixed.

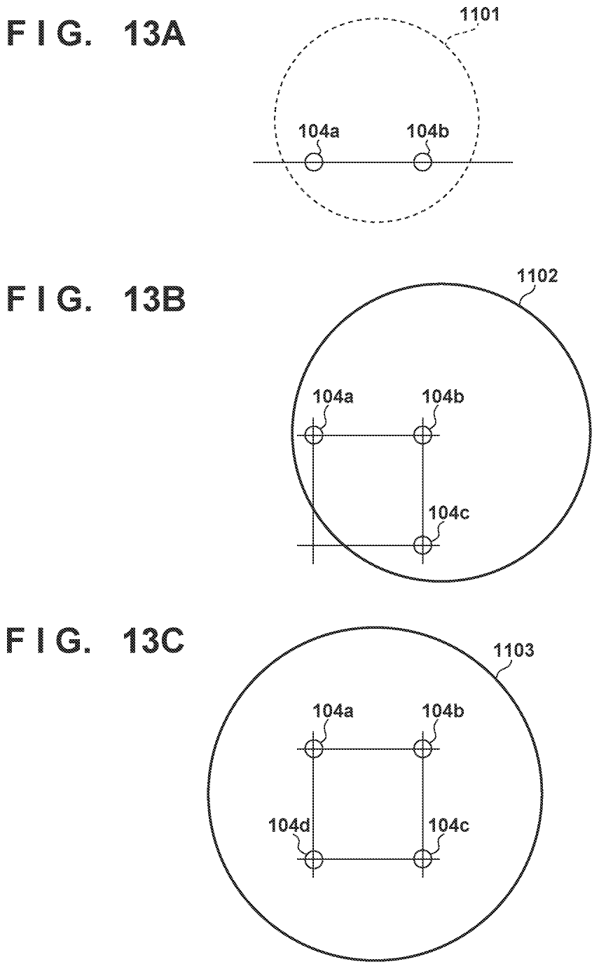

FIGS. 13A to 13C are diagrams illustrating the directivity of mics that can be obtained using the respective methods illustrated in FIGS. 12A to 12C. Note that the determination methods of the sound source direction illustrated in FIGS. 12A to 12C are the same as those illustrated in FIG. 9A to 9C, and therefore the detailed description thereof is omitted, and a brief description will be given in the following.

FIG. 12A illustrates the sound direction detection method when it has been determined that the image capturing apparatus 1 is hung from the user's neck in the processing shown in FIG. 11. The principle of deriving the sound source direction itself is the same as that shown in FIG. 9A. θ[a−b] relative to one side that is the distance d[a−b] between the mics 104a and 104b is obtained. The sound source direction has two candidates, namely an angle θ[a−b] and an angle θ[a−b]′, but the angle θ[a−b]′ that is directed toward the user's body can be ignored. Also, the power to the mics 104c and 104d may be cut off, as described above. Note that the range enclosed by a broken line denoted by a reference sign 1101 in FIG. 13A illustrates the range of the sound source direction that can be detected by this detection method. As illustrated, the forward detection range of the sound direction is broader than the rearward detection range, but this is not a problem because the user's body is present in the rearward direction.

FIG. 12B illustrates the sound direction detection method when it has been determined that the image capturing apparatus 1 is attached to the user's shoulder, in the processing shown in FIG. 11. The direction of the user's head is assumed to be a lower left direction in the diagram. When the image capturing apparatus 1 is attached to the user's shoulder, θ[a−b] relative to one side that is the distance d[a−b] between the mics 104a and 104b is obtained. Thereafter, θ[c−b] relative to one side that is the distance d[c−b] between the mics 104b and 104c is obtained, and the angle of the sound source position is obtained in correlation with θ[a−b]. Power to one of the four mics is cut off, and power is supplied to the remaining three mics as long as the sound direction detection unit 2044 is in operation. The range denoted by a reference sign 1102 in FIG. 13B illustrates the range in which the sound source direction can be detected by this detection method. As illustrated, the detection range of the sound direction is narrow in the lower left direction, but this is not particularly a problem because the user's body is present in this direction.

FIG. 12C illustrates the sound direction detection method when it has been determined that the image capturing apparatus 1 is not attached to a mobile body such as the user, but is fixed, in the processing shown in FIG. 11. In this case, power is supplied to all four mics, and the sound direction using the four mics is performed. The range denoted by a reference sign 1103 in FIG. 13C illustrates the range of the sound source direction that can be detected by this detection method. As illustrated, the detection range of the sound direction is evenly distributed, and the sound source direction can be evenly detected in all directions.

As described above, the position at which the image capturing apparatus is attached is detected, and the detection method of sound direction is selected in accordance with the detected information, and as a result, the directivity of mics suitable for the attachment position can be secured when sound direction is detected, and the detection accuracy can be improved.

### Second Embodiment

A second embodiment will be described. The configuration of the apparatus is assumed to be the same as that of the first embodiment described above, and the description thereof will be omitted, and the differences therefrom will be described.

A case is considered where the image capturing apparatus 1 is fixed in a corner of a room, in order to shoot people in the room. However, when the sound direction detection unit 2044 has erroneously detected that a sound source is present in a direction of a wall close to the installation position due to some reason, the lens unit 101, according to the embodiment described above, once performs a meaningless panning operation so as to direct the image capturing direction (optical axis direction) in the direction of the wall.

Therefore, in the second embodiment, the central control unit 201 sets a valid range (or an invalid range) of the sound direction to the sound direction detection unit 2044. A case will be described where, only if the sound direction detected in the sound direction detection processing is in the valid range, the sound direction detection unit 2044 stores sound information indicating the detected direction in the internal buffer 2044a. In other words, an example will be described in which, if the sound direction detected in the sound direction detection processing is in the invalid range, the sound direction detection unit 2044 does not store information indicating the detected sound direction in the internal buffer 2044a, and ignores (masks) the detection result.

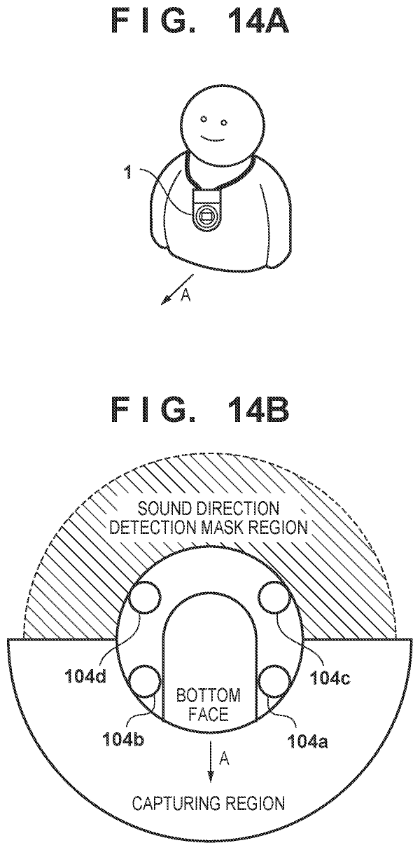

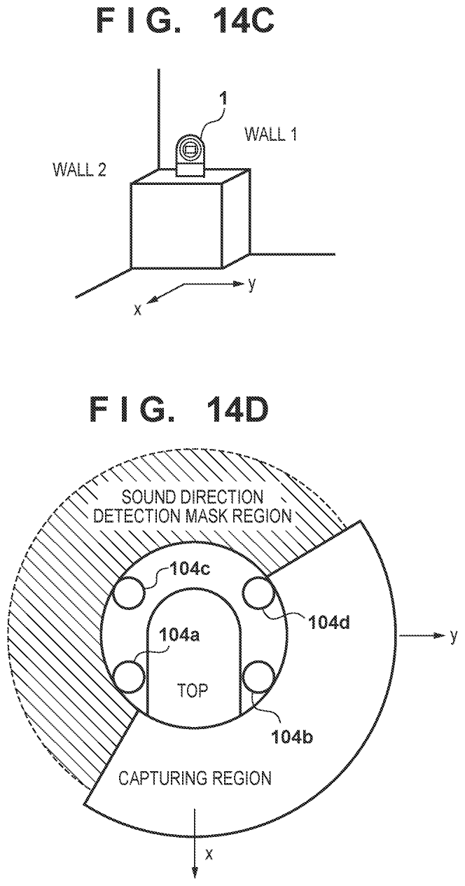

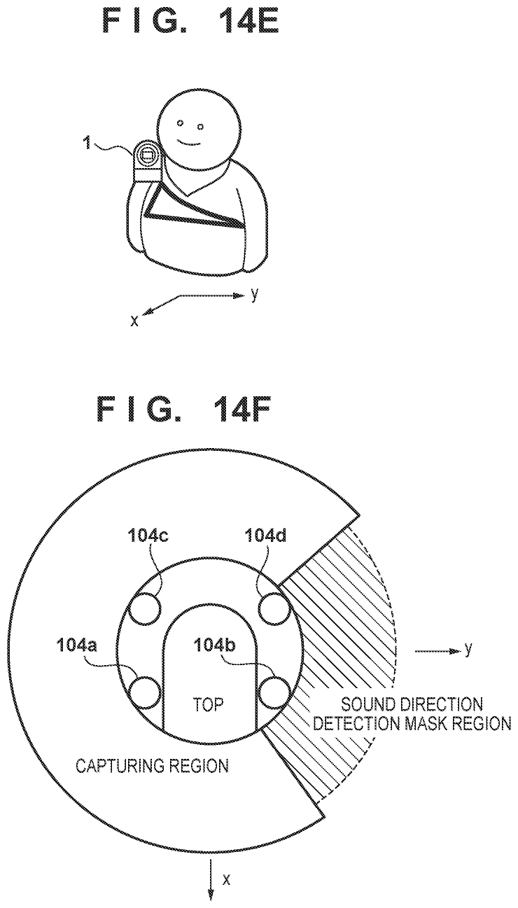

FIGS. 14A to 14F are diagrams illustrating the relationship between the use modes of the image capturing apparatus 1 envisioned in the second embodiment and corresponding masked regions.

FIG. 14A illustrates an example in which the image capturing apparatus 1 is hung from a user's neck. When the direction indicated by the illustrated arrow A is defined as a forward direction of the user, FIG. 14B is a transparent view of the image capturing apparatus 1 seen from a bottom face thereof. As illustrated, the region on the side of mics 104a and 104b is a region that can be shot by the image capturing apparatus 1. Conversely, it can be understood that the region on the side of mics 104c and 104d is a region that need not be shot. Therefore, the central control unit 201 sets, to the sound direction detection unit 2044, a predetermined range (range of 180 degrees in the diagram) centered about the user's body direction as a masked region of sound direction detection. In accordance with the setting, if the detected sound direction is in the set masked region, the sound direction detection unit 2044 does not store the sound direction information indicating the sound direction to the buffer memory 2044a. In other words, only if the detected sound direction is outside the set masked region, the sound direction detection unit 2044 stores the sound direction information in the buffer memory 2044a. As a result, the central control unit 201 will not perform a panning operation such that the image capturing direction (optical axis direction) of the lens unit 101 is directed toward the masked region.

FIG. 14C illustrates an example in which the image capturing apparatus 1 is placed close to walls at a corner of a room. In this case, as shown in FIG. 14D, a range of appropriate angles (e.g., 200 degrees) centered about the direction toward the corner, when seen from above the image capturing apparatus 1, is set as the masked region.

FIG. 14E illustrates an example in which the image capturing apparatus 1 is attached to a user's shoulder. FIG. 14F shows the masked region when seen from above the user. As illustrated, the region including the direction where the user's head is present is the masked region.

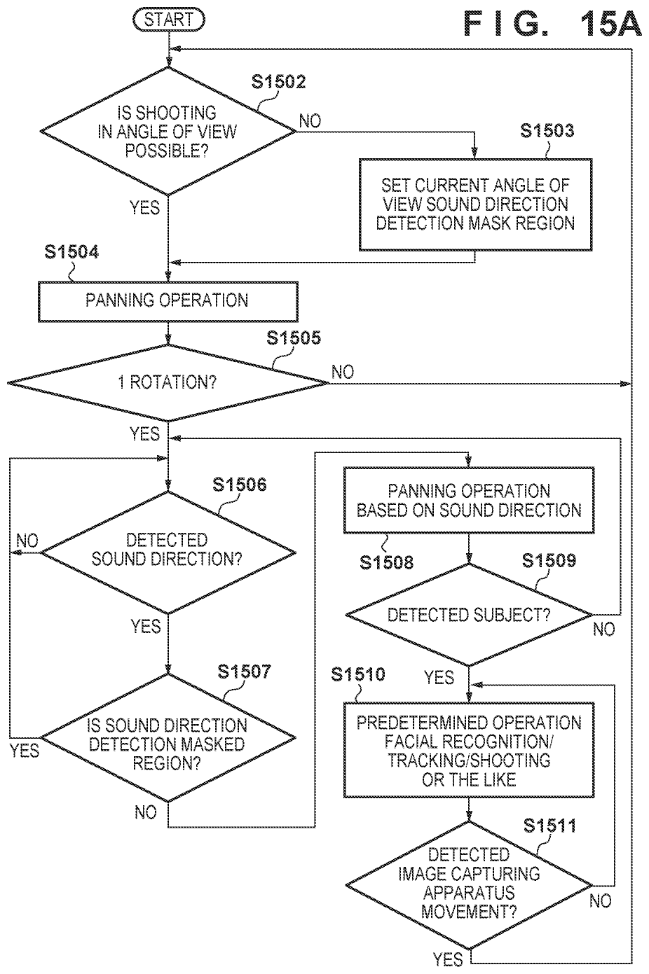

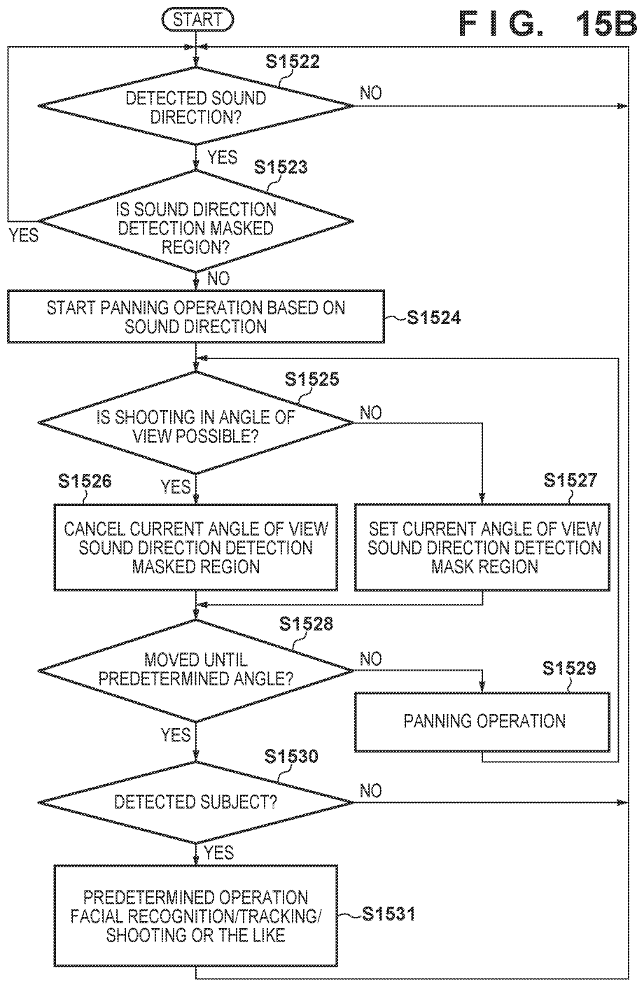

Next, the processing performed by the central control unit 201 in the second embodiment will be described with reference to the flowchart in FIG. 15A. It should be noted that FIG. 15A only shows main processes to be performed by the central control unit 201 including a masked region setting. Also, in the following, a description will be given assuming that the job of automatic moving image shooting and recording in step S217 in FIG. 6 is being executed.

When the mode is shifted to the automatic moving image shooting mode, in step S1502, the central control unit 201 confirms whether the current angle of view range covers a region that needs to be shot from the outputs of the image capturing unit 102 and the image capturing signal processing unit 202. The determination method includes a method of determining whether the obtained image has luminance of a predetermined value or more, whether a subject is present at a position that can be brought into focus by the lens actuator control unit 103, or whether the subject is too close. The determination may be made by obtaining the distance to a subject using a range sensor, a distance map, or the like.

If it is determined that a portion of or the entirety of the current angle of view need not be shot, in step S1503, the central control unit 201 saves the angle to the storage unit 206 as a sound direction detection masked region.

In step S1504, the central control unit 201 causes the movable image capturing unit 100 to perform a panning operation by a preset unit angle by controlling the pivoting control unit 213. Also, in step S1505, the central control unit 201 repeats the processing in step S1502 onward until it is determined that the panning operation has reached 360 degrees (one rotation). As a result, because a plurality of angles to be masked are stored in the storage unit 206, the central control unit 201 determines the range including the plurality of angles that is sandwiched by the angles at both ends of the plurality of angles as the masked region. Here, the operation for determining the initial sound direction detection masked region is completed.

Thereafter, it is assumed that, in step S1506, the sound direction detection unit 2044 has detected a sound source direction. In this case, in step S1507, the sound direction detection unit 2044 determines whether or not the sound source direction is inside the previously determined masked region. If the detected sound source direction is inside the masked region, the sound direction detection unit 2044 ignores the sound source direction. That is, the sound direction detection unit does not store the sound direction information to the internal buffer memory 2044a, and returns the processing to step S1506.

On the other hand, if the detected sound direction is outside the masked region, the sound direction detection unit 2044 stores the detected direction in the internal buffer 2044a. As a result, the central control unit 201 understands that the sound direction detection unit 2044 has detected a sound direction, and therefore, in step S1508, causes the movable image capturing unit 100 to perform a panning operation so as to direct the movable image capturing unit 100 toward the sound source direction by controlling the pivoting control unit 213.

Also, in step S1509, if the central control unit 201 cannot detect a subject in the image acquired via the video signal processing unit 203, the central control unit 201 returns the processing to step S1506 and continues the state of waiting for sound direction detection.

On the other hand, if a subject is included in the captured image, in step S1510, the central control unit 201 executes a job such as facial recognition, tracking, still image shooting, or moving image shooting. Here, in step S1511, the movement of the image capturing apparatus 1 is detected using the gyroscope and the acceleration sensor of the position detection unit 212. If the movement of the image capturing apparatus 1 is detected by the position detection unit 212, the central control unit 201 determines that the image capturing apparatus 1 is being carried. Then, the central control unit 201 returns the processing to step S1502, and again performs processing for setting the sound direction detection masked region.

FIG. 15A shows a processing flow in which the masked region setting processing is performed in preprocessing that is usually used by the image capturing apparatus 1. The processing in which the sound direction detection masked region is updated as needed will be described with reference to the flowchart in FIG. 15B. It should be noted that only main processes to be performed by the central control unit 201 including the masked region setting will be described in the following description as well. That is, in the flowchart in FIG. 15B, power control such as that related to the activation command described in the first embodiment is omitted, and only the setting of masked region and the main part of processing from the sound direction detection to the processing based on the voice command are illustrated.

In step S1522, the central control unit 201 waits for the detection of a sound direction by the sound direction detection unit 2044. When a sound direction is detected, in step S1523, the central control unit 201 determines whether or not the detected sound source direction is in the sound detection masked region, and if the sound source direction is in the masked region, ignores the sound direction, and returns the processing to step S1522. Note that, in the initial state, the masked region of sound direction detection is not set. Therefore, the central control unit 201 advances the processing to step S1524, and causes the movable image capturing unit 100 to start a panning operation so as to direct the movable image capturing unit 100 toward the sound source direction by controlling the pivoting control unit 213.

After the panning operation has been performed for a predetermined period, in step S1525, the central control unit 201 confirms whether or not the angle of view range covers a region needed to be shot from the output of the video signal processing unit 203. The determination method includes a method of determining whether the obtained image has luminance of a predetermined value or more, whether a subject is present at a position that can be brought into focus by the lens actuator control unit 103, or whether the subject is too close to be brought into focus. The determination may be made by obtaining the distance to a subject using a range sensor, a distance map, or the like.

If it is determined that a portion of or the entirety of the current angle of view need be shot, in step S1526, the central control unit 201 saves the direction (angle) by canceling the setting of the sound direction detection masked region. Conversely, if it is determined that a portion of or the entirety of the current angle of view need not be shot, in step S1527, the central control unit 201 saves the direction (angle) as the sound direction detection masked region.

Also, in step S1528, the central control unit 201 determines whether or not the sound source direction detected in the former step S1522 has been reached. If not, in step S1529, the central control unit 201 performs a panning operation for a predetermined period. Then, the central control unit 201 returns the processing to step S1525.

In step S1528, the central control unit 201, upon determining that the panning operation toward the direction of the sound source has been performed, advances the processing to step S1530. In step S1530, the central control unit 201 detects a subject (face) in an image obtained via the video signal processing unit 203. If a subject cannot be detected, the central control unit 201 returns the processing to step S1522, and returns the processing to the state of waiting for sound direction detection. On the other hand, if a subject can be detected in the image obtained by the video signal processing unit 203, the central control unit 201 advances the processing to step S1531, and performs a predetermined operation such as tracking, still image shooting, or moving image shooting in accordance with the recognized voice command.

As described above, as a result of enlarging or reducing the sound direction detection masked region, detection results of the sound direction detection unit 2044 only in optimum directions can be obtained.

As described above, as a result of performing updating processing for enlarging or reducing the sound direction detection masked region, detection results of the sound direction detection unit 2044 only in optimum directions can be obtained.

### Third Embodiment

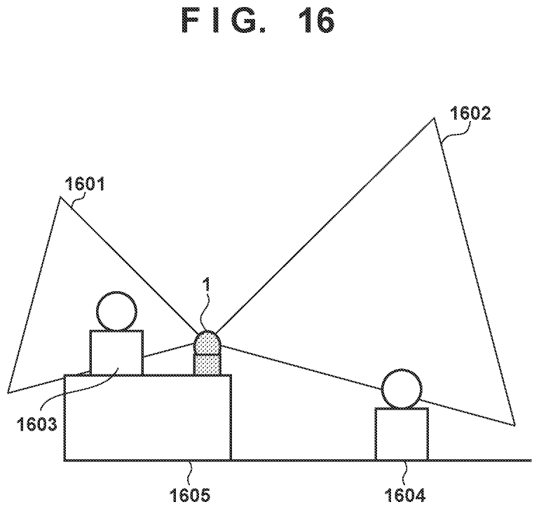

An example in which this third embodiment is applied to the automatic moving image recording job in step S217 in FIG. 6 will be described. FIG. 16 is a schematic diagram illustrating the case where the image capturing apparatus 1 is fixed on a podium 1605, and subjects (faces thereof) 1603 and 1604 are at different heights (a case where one person is standing up, and the other is seated is easy to understand).

In FIG. 16, it is assumed that while the image capturing apparatus 1 is shooting the subject 1603 (reference sign 1601 denotes the angle of view at this time), the subject 1604 says something, thereafter. In this case, the image capturing apparatus 1 can detect the angle (pan angle) of the subject 160 in the horizontal direction, but cannot detect the angle (tilt angle) of the subject 1604 in the vertical direction (the illustrated reference sign 1602 denotes the angle of view when a panning operation has been completed with the tilt angle not yet determined). Therefore, after the panning operation, the subject needs to be detected by gradually performing the tilting operation.

However, when the shooting of the subject 1603 and the subject 1604 is alternatingly repeated, the subject needs to be searched for by performing the tilting operation of the angle of view every time a panning operation is performed, and therefore it takes a longer time until the subject is detected. Also, when a moving image is recorded, there is a problem that a moving image in which the angle of view moves, which causes a user to feel a sense of incongruity, may be recorded.

Therefore, in the third embodiment, once the subject has been recognized, the pan and tilt angles representing the image capturing direction (optical axis direction) of the lens unit 101 at this time are learned (stored). Also, if the sound direction detected by the sound direction detection unit 2044 is in an allowable range less than or equal to a preset threshold value relative to the learned direction (if the two directions substantially match), the time needed to perform the panning and tilting operations is reduced by executing the panning and tilting operations at the same time toward the learned direction such that the image capturing direction (optical axis direction) of the lens unit 101 matches the learned direction. Note that when the pan and tilt angles are learned, the direction (pan of 0 degrees) in the horizontal plane of the lens unit 101 when the image capturing apparatus 1 is activated and the horizontal direction (tilt of 0 degrees) of the tilt range are set as the reference angles, as described in the first embodiment, and the differences therefrom are recorded in the storage unit 206.

FIG. 17 shows a flowchart illustrating the processing procedure of the automatic moving image recording job (step S217 in FIG. 6) of the central control unit 201 in the third embodiment. Note that it is assumed that shooting and recording of a moving image with sound has already been started before this processing is started.

First, in step S1701, the central control unit 201 waits until a sound source direction is detected by the sound direction detection unit 2044. When the sound source direction is detected, the central control unit 201 advances the processing to step S1702, and determines the direction and angle of the panning operation from the current image capturing direction (optical axis direction) of the lens unit 101 and the detected sound source direction. Also, in step S1703, the central control unit 201 determines whether or not the subject information that matches the sound source direction detected this time is already registered in the storage unit 206. In the image capturing apparatus 1 of the present embodiment, past subject information can be saved in the storage unit 206. As a result of accumulating information regarding the time at which subject detection has been performed, the angle (pan angle) in the horizontal direction, and the angle (tilt angle) in the vertical direction as the past subject information, effective clues can be obtained for subject detection when shooting is newly performed.

In step S1703, the central control unit 201, upon determining that past subject information that matches the sound source direction detected this time is present, shifts the processing to step S1704. Also, in step S1703, the central control unit 201, upon determining that subject information that matches the sound source direction detected this time is not present, advances the processing to step S1706.

In step S1704, the central control unit 201 determines the direction and angle of the tilting operation from the tilt angle indicated by the subject information that is determined to match the sound source direction detected this time and the current tilt angle. Also, in step S1705, the central control unit 201 executes the panning and tilting operations in parallel such that the image capturing direction (optical axis direction) of the lens unit 101 is directed toward the target direction over the shortest distance based on the information regarding the direction and angle of the panning operation determined in the former step S1702 and the direction and angle of the tilting operation determined in step S1704. In this way, when the positional relationship between the image capturing apparatus 1 and the subject has not changed from a point in time at which past subject information was detected, the subject can be detected with one angle of view movement, and the time needed to detect the subject can be minimized. Therefore, even when a moving image is recorded using the image capturing apparatus 1, a moving image in which the angle of view is moved without causing the user to feel a sense of incongruity can be recorded.

In step S1706, the central control unit 201 directs the image capturing direction (optical axis direction) of the lens unit 101 to the detected sound source by performing the panning operation. Also, the central control unit 201 advances the processing to step S1707.

In step S1707, the central control unit 201 detects a subject from a current captured image obtained from the video signal processing unit 203. When a subject is detected, the processing is shifted to step S1708, and shooting of the subject is performed. Here, if subject information having a difference in an allowable range from the current pan angle is present in the storage unit 206, the central control unit 201 updates the pan and tilt angles in the subject information in accordance with the current line of sight of the lens unit 101. Also, if subject information having a difference in an allowable range from the current pan angle is not present in the storage unit 206, the central control unit 201 registers the pan and tilt angles indicating the current image capturing direction (optical axis direction) of the lens unit 101 to the storage unit 206 as new subject information.

On the other hand, in step S1707, if a subject has not been detected after the angle of view has been moved, the central control unit 201 advances the processing to step S1709. In step S1709, the central control unit 201 moves (performs tilting operation) the image capturing direction (optical axis direction) of the lens unit 101 to the vertical direction, and searches a subject. Also, in step S1710, the central control unit 201 determines whether or not a subject has been detected. If a subject has been detected, the processing is advanced to step S1708. When the processing is advanced to step S1708, new subject information is registered in the storage unit 206.

Also, in step S1710, if a subject has not been detected, the central control unit 201 advances the processing to step S1711, and performs error processing. This error processing may be processing for continuing shooting and recording while remaining at the current position, for example, but may be processing for returning the image capturing direction (optical axis direction) of the lens unit 101 to that at a point in time at which it was determined that a sound source direction has been detected, in step S1701. Also, it is possible that the subject has moved, and therefore the processing may be processing for deleting subject information in which the pan angle is in an allowable range from the pan angle in the current horizontal plane of the lens unit 101 from the storage unit 206.

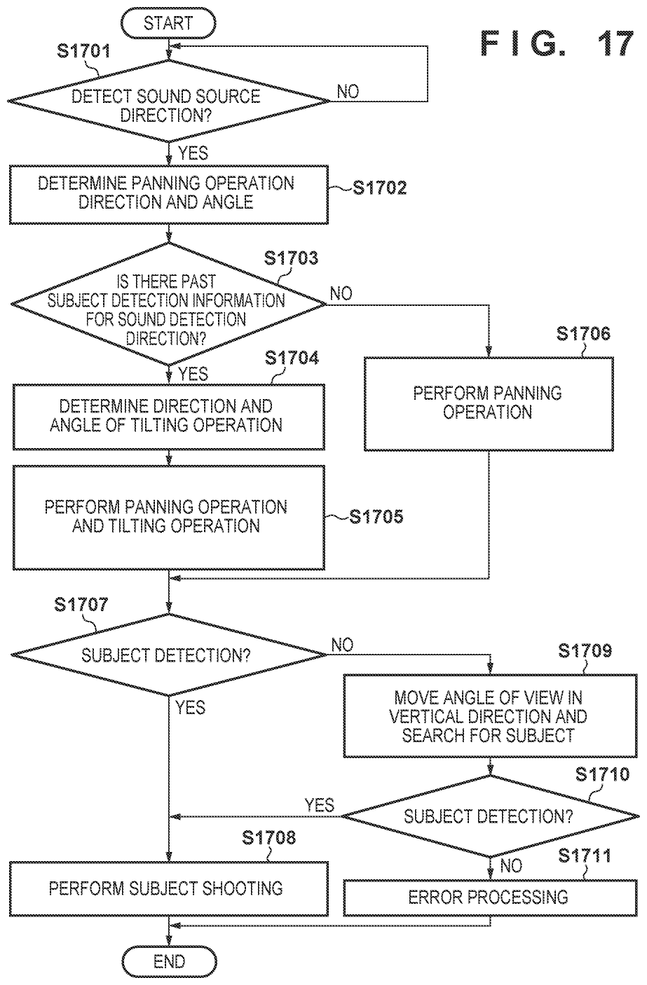

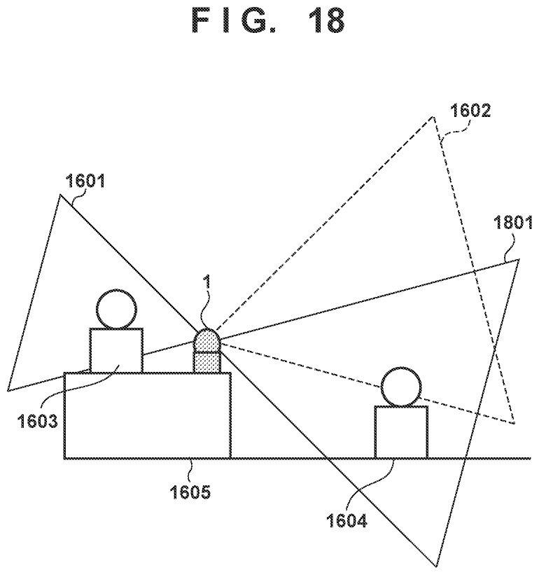

FIG. 18 is a diagram schematically illustrating the control of the image capturing apparatus of the third embodiment. It is assumed that the image capturing apparatus 1 could have detected a subject 1604 by performing panning and tilting operations, which is caused by the subject 1604 having spoken. In this case, when the subject 1604 speaks next time, the image capturing apparatus 1 of the present embodiment can immediately control the panning and tilting operations such that the angle of view of the lens unit 101 is shifted to that denoted by a reference sign 1801 over the shortest distance.

Next, a modification of the third embodiment will be described. In the following as well, an example in which the technique is applied to a job of automatic moving image recording in step S217 in FIG. 6 will be described.

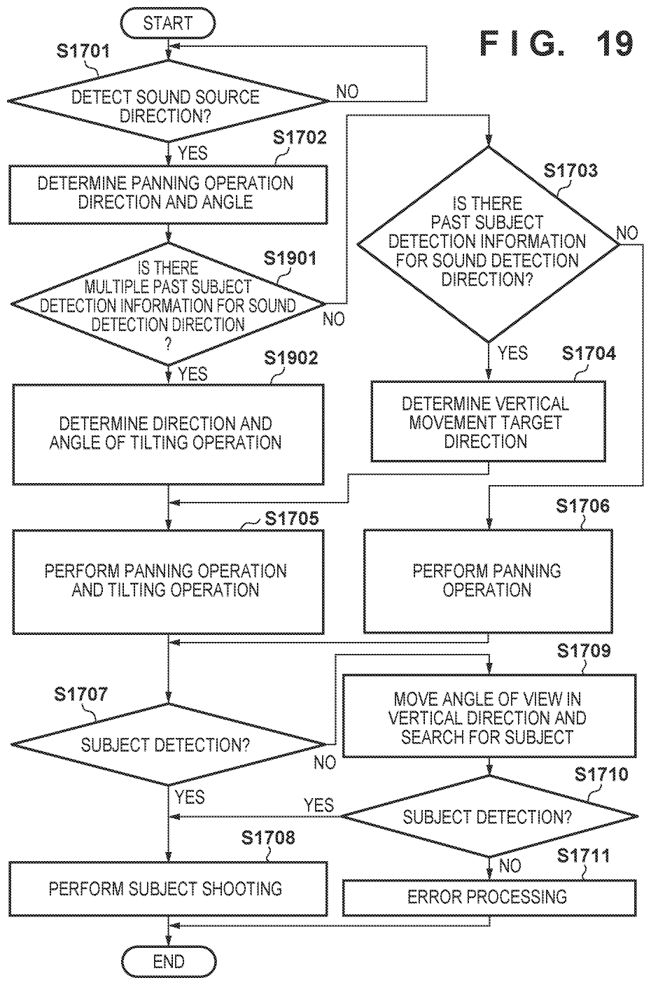

FIG. 19 shows a flowchart illustrating a processing procedure during the job of automatic moving image recording is performed by the central control unit 201, in this modification. Note that it is assumed that shooting and recording of a moving image with sound has already been started before this processing is started.

The processing differs from the processing shown in FIG. 17 in that steps S1901 and S1902 are added.

First, in step S1701, the central control unit 201 waits until a sound source direction is detected by the sound direction detection unit 2044. If the sound source direction has been detected, in step S1702, the central control unit 201 determines the direction and angle of the panning operation based on the current image capturing direction (optical axis direction) of the lens unit 101 and the detected sound source direction.

Next, in step S1901, the central control unit 201 performs determination as to whether or not a plurality of pieces of information regarding subjects in a preset range centered about a target direction are present in the storage unit 206. If it is determined that a plurality of pieces of information regarding subjects in the sound source direction detected this time are present, the central control unit 201 shifts the processing to step S1902. Also, if only one piece of information regarding a subject is present or the information regarding a subject is not present, the central control unit 201 advances the processing to step S1703.

In step S1902, the central control unit 201 determines a target tilt angle such that a plurality of subjects are brought into the angle of view of the lens unit 101. Also, the central control unit 201 advances the processing to step S1705.

The processing in step S1703 and onward is the same as that shown in FIG. 17, and therefore the description thereof is omitted.

As a result of the processing described above, if a plurality of subjects are positioned at almost the same place, and one of them speaks, shooting can be performed such that the plurality of subjects including the subject that has actually spoken are in the angle of view, and therefore a moving image that will not cause a user to feel a sense of incongruity can be recorded.

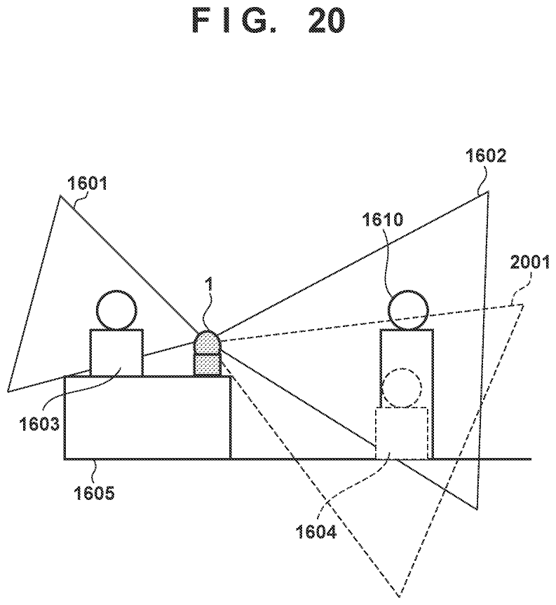

For example, as shown in FIG. 20, in the situation in which subjects 1604 and 1610 are at close positions, and both pieces of subject information are registered in the storage unit 206, and if the subject 1604 speaks, the central control unit 201 performs the panning and tilting operations of the movable image capturing unit 100 such that the angle of view thereof shifts to the illustrated angle of view 2001 over the shortest distance, and therefore natural moving image shooting and recording can be performed.

As described above, according to the third embodiment and its modification, once the subject that spoke is brought into the angle of view of the lens unit 101 and recognized, the pan and tilt angles toward the subject direction relative to the reference direction is stored (learned) as subject information. Then, in the second time and later, if the pan angle of the sound direction detected by the sound direction detection unit 2044 substantially matches the pan angle of the stored subject information, the movable image capturing unit 100 is moved by executing the panning and tilting operations at the same time so as to be the pan and tilt angles indicated by the stored subject information. As a result, natural switching of subjects is performed, and recording of a moving image, which will feel only slightly incongruent to the user, can be performed.

### Fourth Embodiment

A fourth embodiment will be described. An example in which the detection accuracy of sound direction detected by the sound direction detection unit 2044 can be changed will be described in the fourth embodiment. The detection principle of sound direction to be performed by the sound direction detection unit 2044 has already been described. One method of improving the detection accuracy of sound direction detection is to increase the number of detections per unit time and obtain the average value thereof. However, increasing the number of detections per unit time incurs an increase in the load of the sound direction detection unit 2044, that is, an increase in the operating rate, and as a result, the power consumption of the image capturing apparatus 1 increases.

Therefore, in the fourth embodiment, an example in which the detection accuracy of sound direction detected by the sound direction detection unit 2044 can be changed, and the accuracy is increased or decreased as needed will be described.

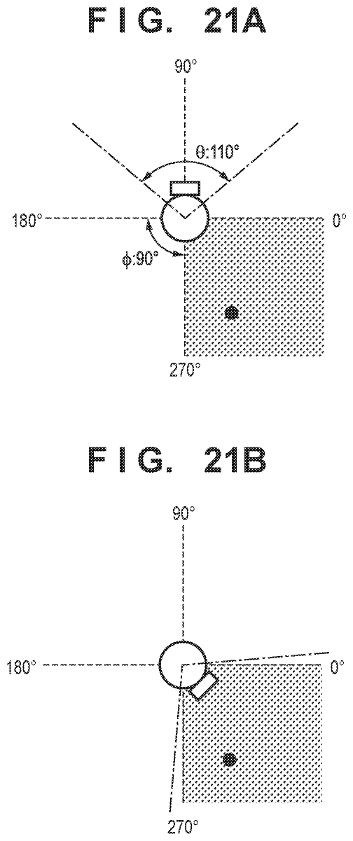

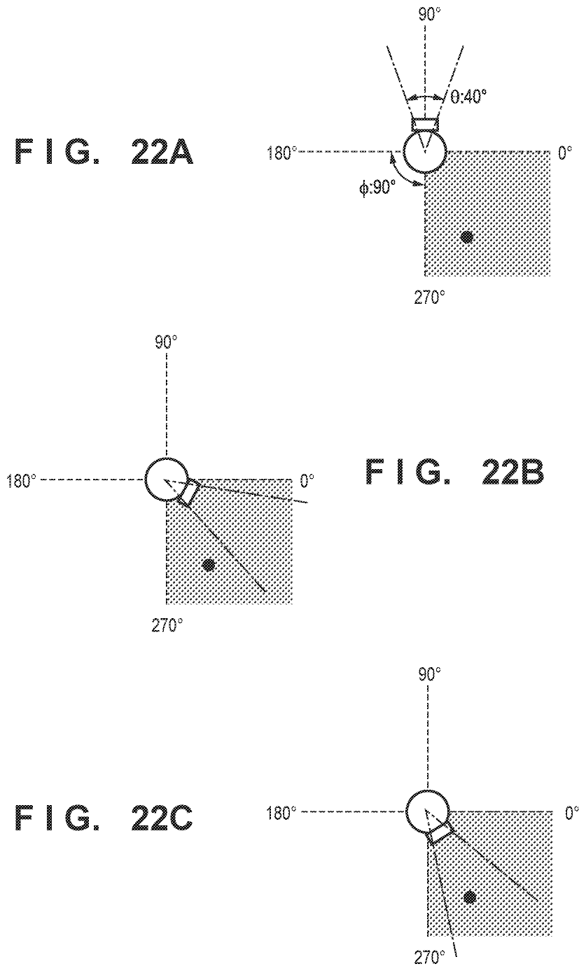

FIGS. 21A and 21B and FIGS. 22A to 22C are diagrams illustrating the relationship between the shooting angle of view of the image capturing apparatus 1 in the horizontal direction and the detection resolution of sound direction detection in the horizontal direction, in exemplary shooting. In FIGS. 21A and 21B and FIGS. 22A to 22C, the right coordinate direction is defined as a reference direction of 0°, and the counter-clockwise rotating direction is defined as a positive direction. Also, the angle indicated by a one dot chain line is the shooting angle of view θ of the lens unit 101 of the image capturing apparatus 1. FIGS. 21A and 21B show an example of θ=110 degrees, and FIGS. 22A to 22C show an example of θ=40 degrees. Note that a smaller shooting angle of view θ indicates a higher zoom ratio, and conversely a larger shooting angle of view θ indicates a lower zoom ratio. Here, the resolution in angle of the sound direction detection unit 2044 in the horizontal direction is represented as sound direction detection resolution φ. Also, the filled circle in the diagram indicates the position of a sound source detected by the sound direction detection unit 2044.

FIGS. 21A and 21B illustrate exemplary shooting when shooting angle of view θ>sound direction detection resolution φ. As described above, the shooting angle of view θ is 110°, and the sound direction detection resolution φ is 90°. The sound direction detection resolution φ being 90° means that the sound direction detection range is divided into four. In this case, the sound direction detection result to be output from the sound direction detection unit 2044 indicates one of four directions, that is, 0 to 90°, 90 to 180°, 180 to 270°, and 270° to 360° (0°).

FIG. 22A illustrates an initial state of the image capturing apparatus 1, and the shooting direction is 90°. Also, the subject that speaks is present in a range of coordinates 270° to 360° (0°) indicated by dots. In the exemplary shooting shown in FIG. 21A, after performing sound direction detection, the shooting direction is changed such that the range in which sound direction was detected is covered by the shooting angle of view θ as a result of panning driving, as shown in FIG. 21B, and as a result, the subject can be brought into the shooting angle of view θ.

FIGS. 22A to 22C illustrate exemplary shooting when shooting angle of view θ<sound direction detection resolution φ. In FIGS. 22A to 22C, the shooting angle of view θ is 40°, and the sound direction detection resolution φ is 90°. FIG. 22A illustrates an initial state of the image capturing apparatus 1, and the shooting direction is 90°. Also, the subject that speaks is present in a range of coordinates 270° to 360° (0°) indicated by dots. In the exemplary shooting shown in FIG. 22A, after performing sound direction detection, the shooting direction is changed through panning driving such that the shooting angle of view θ is brought into the range in which sound direction has been detected, as shown in FIG. 22B or 22C. When the shooting direction is changed as shown in FIG. 22C, the subject can be brought into the shooting angle of view θ, but if the shooting direction is changed as shown in FIG. 22B, the subject cannot be brought into the shooting angle of view θ. In this case, the shooting direction needs to be changed to a shooting direction as shown in FIG. 22C by repeatedly performing panning driving in order to bring the subject into the shooting angle of view θ.

As described using FIGS. 21A and 21B and FIGS. 22A to 22C, when shooting angle of view θ>sound direction detection resolution φ, the direction in which sound is detected can be brought into the shooting angle of view with one instance of panning driving, and subject detection can be performed. However, when shooting angle of view θ<sound direction detection resolution φ, it can be understood that it is possible that the direction in which sound was detected cannot be brought into the shooting angle of view with one instance of panning driving, and as a result, there is a problem that operation time and power consumption for subject detection increase due to panning driving being repeatedly performed.

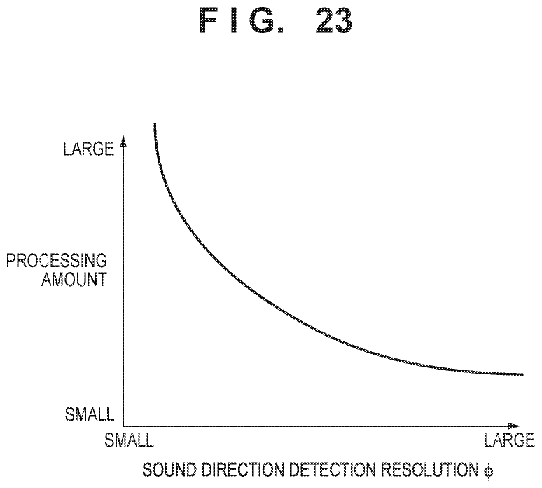

FIG. 23 is a diagram illustrating the relationship between the sound direction detection resolution φ and a processing amount of the sound signal processing unit 2045. There is a relationship in which, as the sound direction detection resolution φ decreases, the processing amount of the sound signal processing unit 2045 per unit time increases, and as the sound direction detection resolution φ increases, the processing amount of the sound signal processing unit 2045 per unit time decreases. That is, if the sound direction detection resolution φ is reduced below what is needed, there is a problem that the processing amount of the sound signal processing unit 2045 will increase, and other processing is affected.

From the above description, it is desirable that the sound direction detection resolution φ is increased as much as possible while satisfying the condition that shooting angle of view θ>sound direction detection resolution φ, with respect to the relationship between the shooting angle of view θ and the sound direction detection resolution φ.

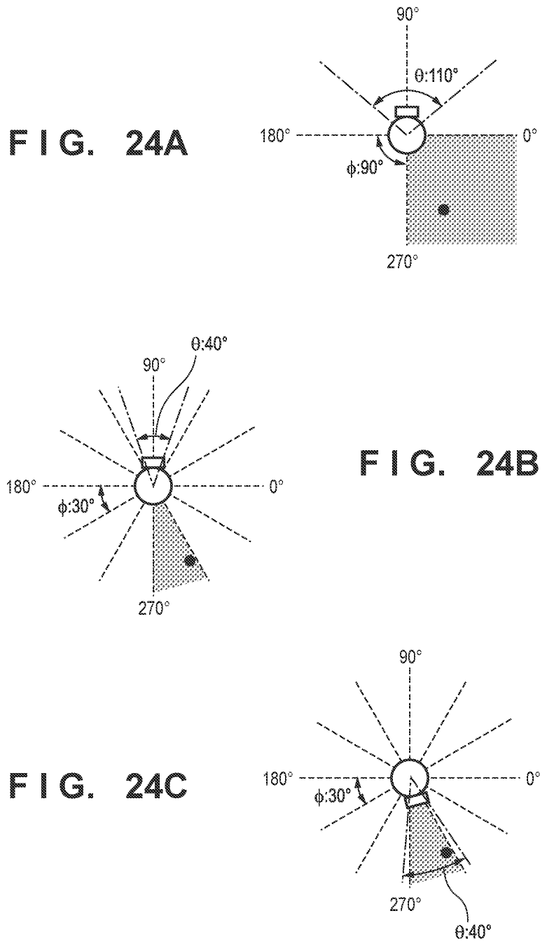

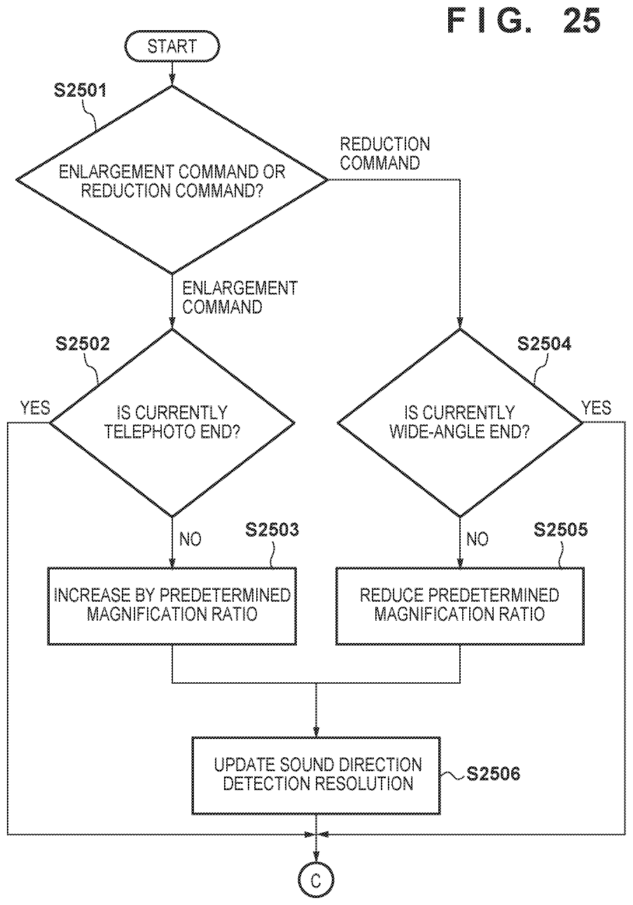

FIGS. 24A and 24B are diagrams illustrating the relationship between the shooting angle of view, in the horizontal direction, of the image capturing apparatus 1 in the fourth embodiment and the detection resolution of sound direction detection in the horizontal direction. FIG. 25 shows a flowchart of processing to be performed by the central control unit 201 when the voice command recognition unit 2043 has recognized an enlargement command or a reduction command. The flowchart in FIG. 25 illustrates a portion of the processing in step S164 in FIG. 5B in the first embodiment. That is, it is the processing to be performed, after step S208, when it is determined that the voice command is the enlargement or reduction command, the processing after step S208 being omitted in FIG. 6.

In step S2501, the central control unit 201 determines which of the enlargement and reduction commands the recognized voice command is. If it is determined that the command is the enlargement command, the central control unit 201 advances the processing to step S2502. In step S2502, the central control unit 201 acquires the current zoom lens position from the lens actuator control unit 103, and determines whether or not the acquired position is at the telephoto end. If the current zoom lens position is a position at the telephoto end, further enlargement is not possible. Therefore, the central control unit 201 ignores the recognized enlargement command, and returns the processing to step S151 in FIG. 5B.

Also, if it is determined that the current zoom lens position has not reached the telephoto end, the central control unit 201 advances the processing to step S2503. In step S2503, the central control unit 201 increases the zoom ratio by a predetermined ratio by controlling the lens actuator control unit 103. Also, the central control unit 201 returns the processing to step S151 in FIG. 5B.

On the other hand, in step S2501, if it is determined that the command is the reduction command, the central control unit 201 advances the processing to step S2504. In step S2504, the central control unit 201 acquires the current zoom lens position from the lens actuator control unit 103, and determines whether or not the acquired position is at the wide angle end. If the current zoom lens position is a position at the wide angle end, further reduction is not possible. Therefore, the central control unit 201 ignores the recognized reduction command, and returns the processing to step S151 in FIG. 5B.

Also, if it is determined that the current zoom lens position has not reached the wide angle end, the central control unit 201 advances the processing to step S2505. In step S2505, the central control unit 201 reduces the zoom ratio by a predetermined ratio by controlling the lens actuator control unit 103. Also, the central control unit 201 returns the processing to step S151 in FIG. 5B.

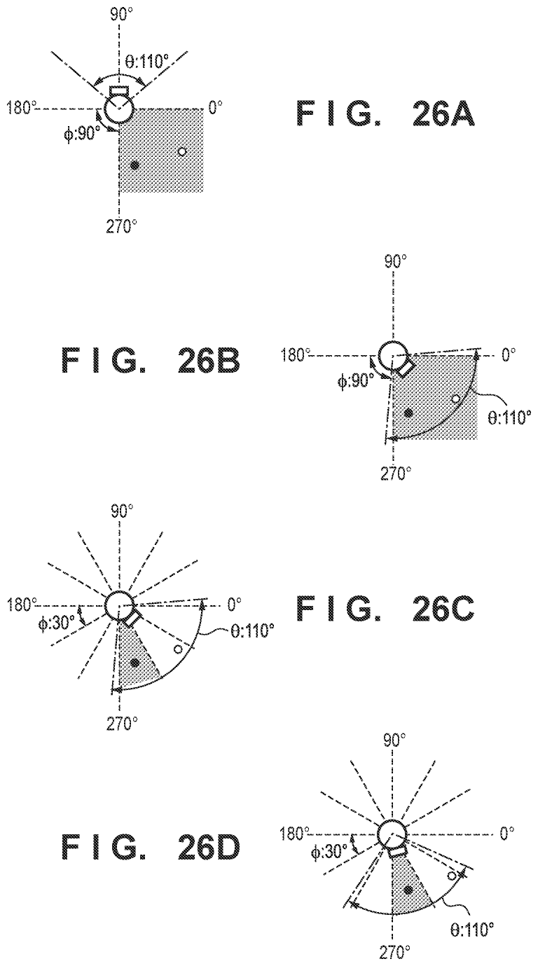

As a result of the above, for example, it is assumed that, currently, the shooting angle of view is 110 degrees, and the lens unit 101 is directed to a direction that is 90 degrees from the reference direction, and the sound direction detection resolution φ is 90 degrees, as shown in FIG. 26A. Also, it is assumed that, at this moment, a person indicated by a filled circle positioned in a coordinate range from 270 degrees to 360 degrees has spoken the enlargement command. In this case, since the sound direction detection resolution φ is 90 degrees, the angle of view of the lens unit 101 as a result of the panning operation is as shown in FIG. 26B. That is, it is possible to bring the subject that spoke into the angle of view of the lens unit 101. However, since this command is to be executed, the angle of view of the lens unit 101 decreases. As a result, as shown in FIG. 26C, it is possible that the subject (filled circle) is outside the updated angle of view of the lens unit 101. However, when the same person speaks the enlargement command, the panning operation is performed in a state in which the sound direction detection resolution φ is set to a resolution higher than the previous time (sound direction detection resolution φ is 30 degrees), and therefore the subject can be brought into the angle of view of the lens unit 101, as shown in FIG. 26D. That is, if a person, which is the subject, repeatedly speaks the enlargement command, the image capturing direction (optical axis direction) of the lens unit 101 is directed to the subject at a higher accuracy, and the enlargement ratio also increases.

As described above, according to the fourth embodiment, even in a case where the shooting angle of view is changed due to zoom driving, the sound detection resolution φ is changed. As a result, a subject that is present outside the angle of view can be effectively brought into the angle of view while suppressing processing time and power consumption by performing the sound direction detection with the changed sound detection resolution φ. Also, when a person to be the subject says the enlargement command, and thereafter says the moving image shooting command, for example, moving image shooting and recording is performed in a state in which the person is enlarged.

In the example described above, the resolution of sound direction is changed in accordance with the voice command relating to zooming made by the user. However, when the panning operation is performed in accordance with a voice command, if a plurality of subjects are present in the captured image, the sound direction resolution may be increased in order to specify the speaker regardless of the zoom ratio.

According to the present disclosure, first, a technique for capturing an image at a timing intended by a user with a composition intended by the user, without the user performing a special operation is provided.

Also, according to another disclosure, in addition to the first effect mentioned above, as a result of changing the number of microphones to be used for direction detection in accordance with the use mode, the sound direction can be prevented from being erroneously detected due to a sound generated by rubbing against clothes when attached to the body of a user or the like, while realizing power saving.

Also, according to another disclosure, in addition to the first effect mentioned above, the image capturing direction is not changed to a meaningless direction.

Also, according to another disclosure, in addition to the first effect mentioned above, the efficiency of movement of the image capturing direction of the image capturing unit toward a subject is improved, as time elapses from the start of usage.

Also, according to another disclosure, in addition to the first effect mentioned above, the accuracy of the direction of the sound source depends on the magnification ratio of the image capturing unit, and therefore the accuracy of detecting a sound source direction need not be kept high, and power consumption can be reduced.

### Other Embodiments

Some Eembodiment(s) of the present disclosure can also be realized by a computer of a system or apparatus that reads out and executes computer—executable instructions (e.g., one or more programs) recorded on a storage medium (which may also be referred to more fully as ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer -executable instructions from the storage medium to perform the functions of one or more of the above-described embodiment(s) and/or controlling the one or more circuits to perform the functions of one or more of the above-described embodiment(s).

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

1. An image capturing apparatus comprising:
an image capturing unit;
a driving unit for moving an image capturing direction of the image capturing unit;
a first detection unit for detecting a direction of a user to whom the image capturing apparatus is attached;
a second detection unit for detecting a movement of the image capturing apparatus;
a sound input unit including a plurality of microphones;
a third detection unit for detecting a direction of a sound source of a voice collected by the sound input unit; and
a control unit,
wherein the control unit determines two or more microphones of the sound input unit, based on the direction of the user detected by the first detection unit and on the movement of the image capturing apparatus detected by the second detection unit,
wherein the third detection unit detects a direction of a sound source of the voice collected by two or more microphones of the sound input unit determined by the control unit, and
wherein, in a case where the third detection unit has detected the direction of the sound source of the voice by the determined two or more microphones of the sound input unit, the control unit controls the driving unit to move the image capturing direction of the image capturing unit to direct toward the direction of the sound source detected by the third detection unit.

2. The image capturing apparatus according to claim 1,
wherein, in a case where a plurality of the directions of the sound source of the voice has detected by the third detection unit, the control unit controls the driving unit to move the image capturing direction of the image capturing unit to direct toward a direction except the direction of the user detected by the first detection unit.

3. The image capturing apparatus according to claim 1,
wherein the second detection unit detects a movement of the image capturing apparatus based on an acceleration and an angular velocity of the image capturing apparatus.

4. The image capturing apparatus according to claim 1,
the plurality of the microphones of the sound input unit are arranged such that not all of the microphones are on a straight line.

5. A control method for controlling an image capturing apparatus including an image capturing unit, a driving unit for moving an image capturing direction of the image capturing unit, a first detection unit for detecting a direction of a user to whom the image capturing apparatus is attached, a second detection unit for detecting a movement of the image capturing apparatus, a sound input unit including a plurality of microphone, and a third detection unit for detecting a direction of a sound source of a voice collected by the sound input unit; the control method comprising:
determining two or more microphones of the sound input unit, based on the direction of the user detected by the first detection unit and the movement of the image capturing apparatus detected by the second detection unit,
performing control the third detection unit to detect a direction of a sound source of the voice collected by the determined two or more microphones of the sound input unit, and
performing control the driving unit to move the image capturing direction of the image capturing unit to direct toward the direction of the sound source detected by the third detection unit in a case where the third detection unit has detected the direction of the sound source of the voice by the determined two or more microphones of the sound input unit.

6. A non-transitory recording medium that records a program for causing an image capturing apparatus comprising an image capturing unit, a driving unit for moving an image capturing direction of the image capturing unit, a first detection unit for detecting a direction of a user to whom the image capturing apparatus is attached, a second detection unit for detecting a movement of the image capturing apparatus, a sound input unit including a plurality of microphone, and a third detection unit for detecting a direction of a sound source of a voice collected by the sound input unit, to execute a control method comprising;
determining two or more microphones of the sound input unit, based on the direction of the user detected by the first detection unit and the movement of the image capturing apparatus detected by the second detection unit,
performing control the third detection unit to detect a direction of a sound source of the voice collected by the determined two or more microphones of the sound input unit, and
performing control the driving unit to move the image capturing direction of the image capturing unit to direct toward the direction of the sound source detected by the third detection unit in a case where the third detection unit has detected the direction of the sound source of the voice by the determined two or more microphones of the sound input unit.

7. An image capturing apparatus comprising:
an image capturing unit;
a driving unit for moving an image capturing direction of the image capturing unit;
a sound input unit including a plurality of microphones;
a detection unit for detecting a direction of a sound source of a voice collected by the sound input unit; and
a control unit,
wherein the control unit sets a region that need not be shot images, based on image data captured by the image capturing unit, and
the control unit controls the driving unit to move the image capturing direction of the image capturing unit to direct toward the direction of the sound source of the voice detected by the detection unit in a case where the direction of the sound source of the voice detected by the detection unit is not in the region.

8. The image capturing apparatus according to claim 7,
wherein the control unit sets an image capturing direction as the region that need not be shot images in a case where the luminance of image data captured by the image capturing unit is low, or in a case where the distance between a subject captured by the image capturing unit and the image capturing apparatus is short.

9. The image capturing apparatus according to claim 7,
in a case where the image capturing apparatus is being carried, the control unit sets a region that need not be shot images.

10. The image capturing apparatus according to claim 7,
the control unit, after performing control to drive the driving unit for a predetermined time, further determines whether or not the current image capturing direction of the image capturing unit is not in the region, and again sets a region that need not be shot images.

11. A control method for controlling an image capturing apparatus including an image capturing unit, a driving unit for moving an image capturing direction of the image capturing unit, a sound input unit including a plurality of microphones, and a detection unit for detecting a direction of a sound source of a voice collected by the sound input unit; the control method comprising:
setting a region that need not be shot images, based on image data captured by the image capturing unit, and
performing controls the driving unit to move the image capturing direction of the image capturing unit to direct toward the direction of the sound source of the voice detected by the detection unit in a case where the direction of the sound source of the voice detected by the detection unit is not in the region.

12. A non-transitory recording medium that records a program for causing an image capturing apparatus comprising an image capturing unit, a driving unit for moving an image capturing direction of the image capturing unit, a sound input unit including a plurality of microphones, and a detection unit for detecting a direction of a sound source of a voice collected by the sound input unit, to execute a control method comprising;
setting a region that need not be shot images, based on image data captured by the image capturing unit, and
performing controls the driving unit to move the image capturing direction of the image capturing unit to direct toward the direction of the sound source of the voice detected by the detection unit in a case where the direction of the sound source of the voice detected by the detection unit is not in the region.

13. An image capturing apparatus comprising:
an image capturing unit;
a driving unit for moving an image capturing direction of the image capturing unit;
a sound input unit including a plurality of microphones;
a detection unit for detecting a pan angle of a direction of a sound source of a voice collected by the sound input unit; and
a control unit,
wherein the control unit, in response that a subject is captured by the image capturing unit, records pan angle and tilt angle of the image capturing direction of the image capturing unit that is directed toward the direction of the subject as subject information,
wherein the control unit controls the driving unit to move the image capturing direction of the image capturing unit to direct toward the pan angle and toward the tilt angle included in the subject information in a case where the difference between a pan angle detected by the detection unit and the pan angle included in the subject information is a threshold value or less, and
wherein the control unit controls the driving unit to move the image capturing direction of the image capturing unit to direct toward the subject at a pan angle detected by the detection unit in a case where the difference between the pan angle detected by the detection unit and the pan angle included in the subject information exceeds the threshold value.

14. The image capturing apparatus according to claim 13,
wherein the control unit controls the driving unit to move the image capturing direction of the image capturing unit to direct toward a pan angle detected by the detection unit and toward the tilt angle included in the subject information, and
wherein the control unit updates the pan angle and the tilt angle included in the subject information to the pan angle and tilt angle of the current image capturing direction of the image capturing unit in a case where a subject is detected in the direction of the pan angle detected by the detection unit and the tilt angle included in the subject information.

15. The image capturing apparatus according to claim 13,
wherein the control unit controls the driving unit to move the image capturing direction of the image capturing unit to direct toward a pan angle detected by the detection unit and toward the tilt angle included in the subject information, and
wherein the control unit deletes the subject information in a case where a subject is not detected in the direction of the pan angle detected by the detection unit and the tilt angle included in the subject information.

16. The image capturing apparatus according to claim 13,
wherein in a case where the difference between the angle detected by the detection unit and each pan angle of a plurality of the subject information is a threshold value or less, the control unit controls the driving unit to the image capturing direction of the image capturing unit to directed toward the pan angle detected by the detection unit and a tilt angle which difference from each tilt angle of a plurality of the subject information is in a predetermined range.

17. A control method for controlling an image capturing apparatus including an image capturing unit, a driving unit for moving an image capturing direction of the image capturing unit, a sound input unit including a plurality of microphones, and a detection unit for detecting a pan angle of a direction of a sound source of a voice collected by the sound input unit; the control method comprising:
recording pan angle and tilt angle of the image capturing direction of the image capturing unit that is directed toward the direction of the subject as subject information in response that a subject is captured by the image capturing unit,
performing control the driving unit to move the image capturing direction of the image capturing unit to direct toward the pan angle and toward the tilt angle included in the subject information in a case where the difference between a pan angle detected by the detection unit and the pan angle included in the subject information is a threshold value or less, and
performing control the driving unit to move the image capturing direction of the image capturing unit to direct toward the subject at a pan angle detected by the detection unit in a case where the difference between the pan angle detected by the detection unit and the pan angle included in the subject information exceeds the threshold value.

18. A non-transitory recording medium that records a program for causing an image capturing apparatus comprising an image capturing unit, a driving unit for moving an image capturing direction of the image capturing unit, a sound input unit including a plurality of microphones, and a detection unit for detecting a pan angle of a direction of a sound source of a voice collected by the sound input unit, to execute a control method comprising;
recording pan angle and tilt angle of the image capturing direction of the image capturing unit that is directed toward the direction of the subject as subject information in response that a subject is captured by the image capturing unit,
performing control the driving unit to move the image capturing direction of the image capturing unit to direct toward the pan angle and toward the tilt angle included in the subject information in a case where the difference between a pan angle detected by the detection unit and the pan angle included in the subject information is a threshold value or less, and
performing control the driving unit to move the image capturing direction of the image capturing unit to direct toward the subject at a pan angle detected by the detection unit in a case where the difference between the pan angle detected by the detection unit and the pan angle included in the subject information exceeds the threshold value.

19. An image capturing apparatus comprising:
an image capturing unit;
a driving unit for moving an image capturing direction of the image capturing unit;
a sound input unit including a plurality of microphones;
a detection unit for detecting a direction of a sound source of a voice; and
a control unit,
wherein the control unit detect a direction of a sound source of the voice with a resolution of a predetermined angle by the sound input unit,
wherein the control unit configures the predetermined angle smaller than an angle of view of the image capturing unit, and
in response that a voice is collected by the sound input unit, the control unit controls the driving unit to move the image capturing direction of the image capturing unit to direct toward a direction of the sound source of the voice detected by the detection unit with the resolution of the predetermined angle.

20. The image capturing apparatus according to claim 19,
the control unit configures the predetermined angle to be decreased to be smaller than an angle of view of the image capturing unit in response that a zoom ratio of the image capturing unit is increased, and

[symbol]

21. The image capturing apparatus according to claim 19, further comprising a recognition unit for recognizing a voice instruction;
wherein the control unit changes the zoom ratio of the image capturing unit in accordance with a voice instruction in a case where the recognition unit recognizes a voice instruction for changing the zoom ratio of the image capturing unit.

22. A control method for controlling an image capturing apparatus including an image capturing unit, a driving unit for moving an image capturing direction of the image capturing unit, a sound input unit including a plurality of microphones, and a detection unit for detecting a direction of a sound source of a voice; the control method comprising:
detecting a direction of a sound source of the voice with a resolution of a predetermined angle by the sound input unit,
configuring the predetermined angle smaller than an angle of view of the image capturing unit, and
performing control the driving unit to move the image capturing direction of the image capturing unit to direct toward a direction of the sound source of the voice detected by the detection unit with the resolution of the predetermined angle in response that a voice is collected by the sound input unit.

23. A non-transitory recording medium that records a program for causing an image capturing apparatus comprising an image capturing unit, a driving unit for moving an image capturing direction of the image capturing unit, a sound input unit including a plurality of microphones, and a detection unit for detecting a direction of a sound source of a voice, to execute a control method comprising;
detecting a direction of a sound source of the voice with a resolution of a predetermined angle by the sound input unit,
configuring the predetermined angle smaller than an angle of view of the image capturing unit, and
performing control the driving unit to move the image capturing direction of the image capturing unit to direct toward a direction of the sound source of the voice detected by the detection unit with the resolution of the predetermined angle in response that a voice is collected by the sound input unit.
